(19) United States
(12) Patent Application Publication
(10) Pub. No.: US 2016/0371355 A1
(43) Pub. Date: Dec. 22, 2016

(54) TECHNIQUES FOR RESOURCE DESCRIPTION FRAMEWORK MODELING WITHIN DISTRIBUTED DATABASE SYSTEMS

(71) Applicant: NuoDB, Inc., Cambridge, MA (US)

(72) Inventors: Alberto Massari, Genova (IT); Keith David McNeill, Cambridge, MA (US); Oleg Levin, Acton, MA (US); Adam Abrevaya, Burlington, MA (US); Seth Theodore Proctor, Arlington, MA (US)

(73) Assignee: NUODB, INC., Cambridge, MA (US)

(21) Appl. No.: 14/744,546

(22) Filed: Jun. 19, 2015

(51) Int. Cl. G06F 17/30; G06F 17/27

(52) U.S. Cl. CPC G06F 17/30578; G06F 17/30958; G06F 17/30463; G06F 17/30961; G06F 17/30949; G06F 17/30607; G06F 17/30371; G06F 17/2705

(57) ABSTRACT

A Resource Description Framework engine is disclosed for performing transactional RDF-based operations against a distributed database. The RDFE manages a local memory cache that stores active portions of the database, and can synchronize those active portions using a transactionally-coherent distributed cache across all database nodes. During RDF reads, the RDFE can identify a triple-store table affected by a given RDF transaction, and can traverse the index objects for that table to locate triple values that satisfy a given RDF query, without intervening SQL operations. The RDFE can also perform SQL transactions or low-level write operations to update triples in triple-store tables. Thus the RDFE can update corresponding index objects contemporaneous with the insertion of RDF triples, with those updates replicated to all database nodes. A user application can instantiate the RDFE during runtime, thus allowing in-process access to the distributed database through which the user application can execute RDF transactions.

### FIELD OF DISCLOSURE

The present disclosure relates generally to database systems, and more particularly to resource description framework modeling in distributed database systems.

### BACKGROUND

The phrase Semantic Web generally refers to the World Wide Web as being a web of data that is machine-understandable. The so-called Resource Description Framework (RDF) is one mechanism by which this machine-friendly data web is achieved and enables automated agents to store, exchange, and use machine-readable information distributed through the Web. More particularly, RDF is a family of World Wide Web Consortium (W3C) specifications designed as a metadata model to describe any Internet resource such as a Website and its content. The basic principle behind RDF is to model data by making statements about resources in the form of subject-predicate-object expressions. These statements are referred to as triples in RDF. For example, one way to represent the notion “the earth is a sphere” in RDF is as the triple formed by a subject denoting “the earth”, a predicate denoting “is”, and an object denoting “a sphere.” Now consider a website having an author, date of publication, a sitemap, information that describes content, keywords, and so on. The website's relations to other Web-based resources can be modeled using RDF triples. These triples, in turn, form the basis for how a computer process utilizes this information to understand relationships, so long as the semantics (meaning) of each piece of the triple is known. RDF's simple data model and ability to model disparate, abstract concepts has also led to its increasing use in other applications unrelated to Sematic Web activity.

Using triples to describe resources within a user application (that may not necessarily be Web-based) is one such example, and using relational databases to persist RDF data for these applications has grown in popularity. However, servicing non-relational data in a relational database is analogous to placing a round peg in a square hole. While a relational database is flexible as to the data it stores within its tables, it expects to service SQL-based queries against that data, with those queries constrained by the database schema. So, in the context of RDF queries, a relational database must first convert an RDF query into a SQL select statement, process the SQL select statement at the server to retrieve and construct a result set, and convert that result set into a RDF-format (e.g., triples). RDF-based tables can hold tens of millions of triples, if not more, and access to these tables in a one-size-fits-all relational manner presents numerous non-trivial challenges when implementing robust RDF capabilities in a relational database.

### BRIEF DESCRIPTION OF THE DRAWINGS

FIG. 1 schematically illustrates an example distributed database system that includes a plurality of interconnected nodes, in accordance with an embodiment of the present disclosure.

FIG. 2a schematically illustrates the architecture of an example transaction engine that forms part of the distributed database system of FIG. 1, in accordance with an embodiment of the present disclosure.

FIG. 2b schematically illustrates the architecture of an example storage manager that forms part of the distributed database system of FIG. 1, in accordance with an embodiment of the present disclosure.

FIG. 2c schematically illustrates the architecture of an example resource description framework engine (RDFE) that forms part of the distributed database system of FIG. 1, in accordance with an embodiment of the present disclosure.

FIG. 3 is a block diagram illustrating an example atom having a no-overwrite structure, in accordance with an embodiment of the present disclosure.

FIG. 4 schematically illustrates an example RDFE configured to service RDF queries against a directed graph persisted within the distribute database system of FIG. 1, in accordance with an embodiment of the present disclosure.

FIG. 5a depicts one example table layout for persisting RDF triples in a column-store format.

FIG. 5b depicts one example table layout for persisting RDF triples in a predicate-layout format and includes a separate table for each predicate.

FIG. 5c depicts one example table layout for persisting RDF triples in a single relational table having multiple predicate columns.

FIG. 5d depicts one example semantic lookup table for mapping resources referenced in triple statements to internal identifiers within the database.

FIG. 5e depicts one example table layout for mapping literals referenced in triple states to internal identifiers within the database.

FIG. 6a is flowchart illustrating one example method for performing an RDF update using a durable distributed cache implemented within the distributed database system of FIG. 1, in accordance with an embodiment of the present disclosure.

FIG. 6b depicts an example Simple Protocol and RDF Query Language (SPAQRL) query configured to cause the distributed database system of FIG. 1 to manipulate a directed graph persisted within a relational table, in accordance with an embodiment of the present disclosure.

FIG. 6c depicts an example directed graph representing triples within a relational table after performance of the example SPARQL query of FIG. 6b, in accordance with an embodiment of the present disclosure.

FIG. 6d depicts an example SPAQRL query configured to cause the distributed database system of FIG. 1 to delete triples from a directed graph persisted within a relational table, in accordance with an embodiment of the present disclosure.

FIG. 6e depicts an example directed graph representing triples within a relational table created after performance of the example SPARQL query of FIG. 6d, in accordance with an embodiment of the present disclosure.

FIG. 6f shows an example data flow illustrating an RDFE node implementing the RDF update method of FIG. 6a, in accordance with an embodiment of the present disclosure.

FIG. 7a is flowchart illustrating one example method for performing an RDF query using a durable distributed cache implemented within the distributed database system of FIG. 1, in accordance with an embodiment of the present disclosure.

FIG. 7b depicts an example SPARQL query configured to cause execution of a query against a directed graph persisted within a relational table, in accordance with an embodiment of the present disclosure.

FIG. 7c depicts an example directed graph representing triples within a relational table that satisfies the search pattern within the example SPARQL query of FIG. 7b, in accordance with an embodiment of the present disclosure.

FIG. 7d depicts an example result set after performance of the SPARQL query of FIG. 7b, in accordance with an embodiment of the present disclosure.

FIG. 7e shows an example data flow illustrating an RDFE node implementing the RDF query method of FIG. 7a, in accordance with an embodiment of the present disclosure.

FIG. 8 depicts a plurality of index objects arranged in a Balanced-tree structure and includes one example search path used during the performance of an RDF query, in accordance with an embodiment of the present disclosure.

FIG. 9 shows a computing system configured to execute one or more nodes of the distributed database system, in accordance with an embodiment of the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION

A Resource Description Framework engine (RDFE) is disclosed for performing transactional RDF-based operations against a distributed database implementing a relational data model (e.g., tables, columns, keys). In an embodiment, the RDFE can subscribe to the distributed database as a member node and securely communicate with other database nodes using a language-neutral communication protocol. This means the RDFE can perform low-level RDF read and write operations during performance of RDF transactions, and can minimize the execution of complex structure query language (SQL) queries. As a member-node, the RDFE manages a local memory area, also referred to as a memory cache, which stores active portions of the distributed database, and can synchronize those active portions with a transactionally-coherent distributed cache that maintains an identical copy of the database within all database nodes. This means database nodes only “see” a consistent version of the database and not partial or intermediate state during performance of concurrent transactions. The RDFE can use the durable distributed cache to retrieve and manipulate database objects during performance of RDF transactions. In more detail, during RDF read operations, the RDFE can identify a triple-store table affected by a given RDF transaction, and load a portion of index objects for that table into the memory cache. Index objects can link and form logical structures, and can enable efficient lookup of RDF values within triple-store tables. Some such examples include logical tree structures, lists, tables, or any combination thereof. The RDFE can traverse these logical structures to locate triple values within index objects that satisfy a search pattern within the given RDF transaction. Thus the RDFE can construct query results primarily by accessing a table index versus loading and evaluating data stored in the table itself. During RDF update requests, the RDFE can also perform SQL transactions or directly perform low-level write operations that add, update, or remove triples stored in triple-store tables. The RDFE can perform such low-level write operations directly against database objects within its memory cache. Consequently, the RDFE also updates corresponding index objects associated with those triple-store tables in accordance with the insertion of new triple records. Moreover, the RDFE replicates those updates to the other database nodes and makes those updates “visible” in all database nodes after a transaction finalizes and commits. So, each database node has “invisible” versions of databases objects within their respective memory cache until a transaction ends and those updates are finalized. This allows the coherent functionality of the durable distributed cache, thereby ensuring each database node “sees” a consistent view of the database. In an embodiment, a user application can instantiate the RDFE during runtime, and thus, allows in-process access to the distributed database through which the user application can execute RDF transactions.

General Overview

As previously noted, storing and servicing RDF data in a relational database presents numerous non-trivial challenges. For example, relational databases can store RDF data in a single triple-store table, with that table having three columns: a subject column, a predicate column, and an object column. To perform RDF queries on such a table, a relational database translates the RDF query into a SQL query, and more precisely, into a query that operates within the constraints of the database's defined schema. By way of illustration, consider one such example table that includes millions of triples that relate to books and their respective authors (“bookX has-author authorY”, “authorY has-name nameZ”). To find all authors of the book titled “Linked Data,” a relational database first performs a SQL SELECT query to locate the triple “bookX has title ‘Linked Data’”. Then, the relational database performs a SELF JOIN on the table to find all of the triples in the form of “personN wrote bookX”. And finally, for each author found, the relational database performs another SELF JOIN to find triples in the form “person has-name nameZ”. In this specific example case, the relational database may return authors “David Wood” and “Marsha Zaidman” to satisfy the RDF query, assuming a triple exists in the table that associates ‘Linked Data’ with each author's name. Thus relational databases use a series of complex SQL iterations to perform even relatively simple RDF queries. As RDF tables grow to hundreds of millions of records, and beyond, the costs associated with these operations can outweigh the benefits of utilizing RDF modeling.

Thus, in an embodiment according to the present disclosure, an RDFE is programmed or otherwise configured such that it allows triple-store tables within a relational database to be traversed in a manner optimized for RDF data, and that minimizes the necessity of complex SQL operations to construct RDF results. In addition, the RDFE allows the performance of RDF transactions by a user application in a so-called “in-process” manner against a private memory cache local to the RDF, wherein the memory cache is part of a durable distributed cache that enables each database node to store an identical copy of the database. For example, a database update (e.g., INSERT, UPDATE, DELETE), performed by a first database node gets replicated to all other database nodes. Thus, when a database client connects to any database node responsible for executing database queries, that client “sees” a same version of the database.

In more detail, the RDFE can comprise a function library within, for example, a dynamically-linked library (DLL), a shared object (e.g., a Linux .so file) or any other compiled, or non-compiled, library or set of classes that user applications can use during runtime. The RDFE can expose predefined interfaces, or an application programming interface (API), or any combination thereof, which enables execution of the RDFE, configuration changes, and performance of RDF transactions. In addition, an application implementing or otherwise comprising the RDFE can reside on an application server and allow remote clients to perform RDF read and write operations, generally referred to herein as an RDF query. As discussed further below, the RDFE can host network end-points configured to receive RDF queries from a remote client. One such example end-point includes a hypertext transfer protocol (HTTP) endpoint servicing Simple Protocol and RDF Query Language (SPARQL) requests, although other endpoint types and protocols will be apparent in light of this disclosure.

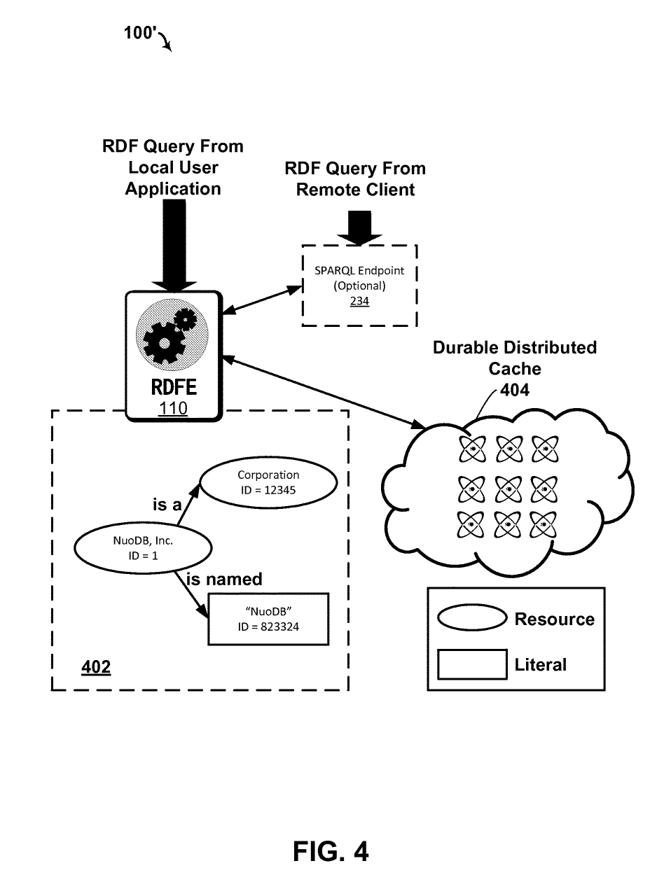

To this end, a user application can comprise or otherwise instantiate the RDFE, with the RDFE allowing in-process RDF read and write operations, and enabling efficient performance of those operations through platform-level functionality provided internally by the distributed database. These RDF operations are generally performed against RDF graphs, also known as directed graphs. Directed graphs refer to a visualization of a collection of RDF statements about a resource. Within an RDF graph, the structure forms a directed, labeled graph, where the edges (or arcs) represent the named link between two resources, with each resource represented by a node in the graph. A visualized graph embodies these principles, and enables RDF to be better understood. One such example directed graph 402 is depicted in FIG. 4.

To this end, and in accordance with an embodiment, the RDFE includes a platform layer, a SQL layer, and a personality layer. The platform layer allows the RDFE to declare membership as a node within the distributed database system, and enables secure communication with other database nodes in a native or otherwise language-neutral manner. Within the platform layer, a memory cache module enables storage of an active portion of the distributed database during read and write operations. For example, the memory cache module can manage a private memory area in random access memory (RAM), and can store database objects representing indexes, tables, columns and records, just to name a few.

In more detail, the personality layer allows servicing of non-SQL transactions, such as RDF queries. During execution of RDF queries, the personality layer can determine an execution plan or scheme optimized for performing queries against triple-store tables. For example, the personality layer can parse the RDF query to determine an execution order that minimizes costs associated with that query. Determination of such costs can include accessing statistics within the distributed database system that detail estimated input/output (IO) costs, operator costs, central processor unit (CPU) costs, and number of records affected by the query, just to name a few. The personality layer can reorder the operations in a query based on those statistics to reduce latencies and optimize execution.

In one embodiment, part of the enhanced execution plan can include bypassing the SQL layer and accessing database objects directly in the memory cache. For example, the personality layer can retrieve one or more index objects associated with a triple-store table using the platform layer and access those index objects using, for example, file system open and read operations. Each index object can reference each other and form a logical index structure. One such example index structure is a Balance-tree (B-Tree) structure. In a general sense, a B-tree is a generalization of a binary search tree in that a node can have more than two children. In databases, B-trees are particularly advantageous for reading large blocks of data. Index objects within B-trees can comprise composite keys, also known as partial keys, that include key-value pairs corresponding to values within records stored in a given table. For example, the columns “subject” and “object” can form one such composite key, with the key corresponding to the subject or the object, and a value corresponding to the other. While example embodiments and aspects disclosed herein discuss B-tree index structures, this disclosure is not necessarily limited in this regard. Numerous other database index structures are within the scope of the disclosure including, for example, B+ tree index structures, Hash-based index structures, and doubly-linked lists just to name a few.

Thus, the personality layer can access index objects within the memory cache, and traverse those objects to locate leaf nodes that include values which satisfy a given RDF query. For instance, consider the earlier example of a triple-store table having millions of triples related to books and their respective authors. To find the author(s) of the book “Learning SPARQL,” an example SPARQL query can be written as SELECT ?author WHERE {?t:title “Learning SPARQL”}. The personality layer can parse this query and identify a triple-store table affected by the query. The RDFE can perform this identification based on a mapping that associates a uniform resource identifier (URI) for a resource referenced within the RDF query to a particular table within the database that persists triples for that resource. This mapping can further include semantic information for each resource referenced by a triple within a given triple store table. Thus, the mapping can link a resource to an internal identifier, and also to a semantic definition for that resource. In some cases, the distributed database determines such internal identifiers by computing a hash value based on each resource's URI.

In Semantic Web Applications, these URIs are often in the form of uniform resource locations (URLs) that can be utilized to access actual data on the world wide web. But, RDF is not limited to merely the description of internet-based resources. To this end, RDF URIs often begin with, for example, “http:” but do not represent a resource that is accessible via an internet browser, or otherwise represent a tangible network-accessible resource. Thus URIs are not constrained to anything “real” and can represent virtually anything. So, producers and consumers of RDF must merely agree on the semantics of resource identifiers.

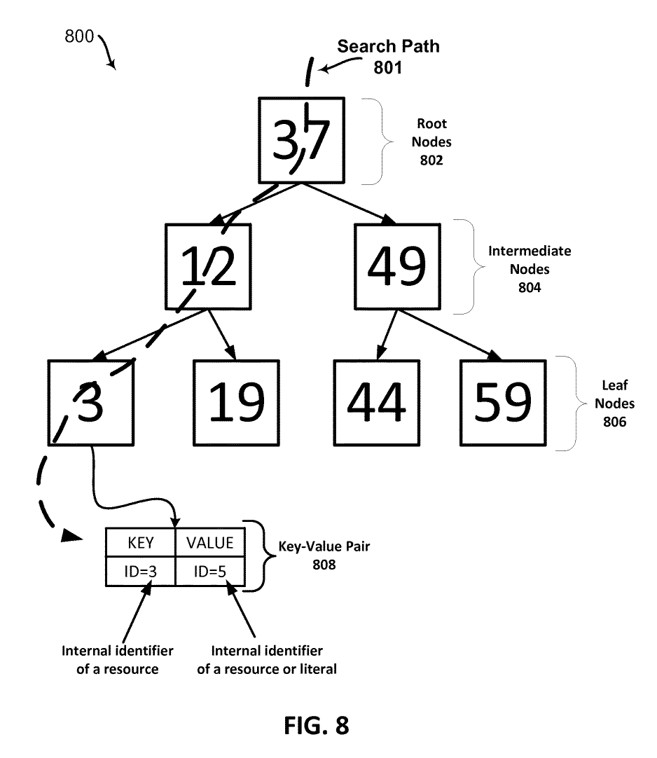

In any event, the RDFE can satisfy a search pattern within an RDF query by locating and traversing table index objects associated with the identified table. Recall that index objects can reference each other and form a logical index structure such as a B-tree, Hash-based index, and so on. One such example B-tree 800 is depicted in FIG. 8 and includes root nodes 802, intermediate nodes 804 and leaf nodes 806. Note that FIG. 8 represents a simplified B-tree structure merely for ease of description and understanding, and this disclosure should not be viewed as limited in this regard. Moreover, and as discussed above, other index structures can be utilized in a similar manner and are within the scope of the present disclosure. As shown, each index object for a particular table is represented by a node within the tree. During performance of a query, the RDFE can retrieve root node 802 from the distributed database system (e.g., from another database node containing root node 802), with the root node representing a first index object for a particular table. Then, the RDFE can load additional nodes, as needed, until locating a node within the leaf nodes 806 that satisfies the search pattern within the RDF query. Returning to the earlier example, the book titled “Learning SPARQL” may have an internal identifier of 3. Thus, the RDFE continues traversing nodes along the search path 801 until encountering the leaf node with ID=3. The leaf node ID=3 includes a key-value pair 808, with the “value” of that pair representing the identifier of a corresponding resource, which in this case equals 5. The RDFE may then translate the identified value into an RDF object by using the mapping discussed above that associates resources with an internal identifier to identify the resource's semantics. Thus, and in an embodiment, the RDFE can construct a result set that primarily leverages table indexes. So, the personality layer can perform an RDF query that uses low-level access to traverse index objects (e.g., file system file-open and file-read operations), without necessarily executing an intervening SQL operation such as a complex table join or other expensive database operation normally required by an equivalent SQL SELECT query.

Note that the schema for the RDF triple-store tables can vary depending on a desired configuration, and consequently, different index structures are within the scope of this disclosure. Some example table layout options will be discussed in turn.

The personality layer also allows the RDFE to perform database write operations. For example, the personality layer can receive an RDF update request that seeks to insert a new triple into a triple-store table. The personality layer can utilize the SQL layer to execute a transaction that inserts that new record into the triple-store table. Alternatively, or in addition to executing a SQL transaction, the RDFE can perform a low-level write operation using the platform layer 254 to insert the triple without necessarily executing a SQL command. This low-level write operation can include the RDFE directly updating database objects within its memory cache. Consequently, the index associated with the triple-store table receives an additional key-value pair that reflects the new triple. The SQL layer also ensures that such database write operations against database objects in the local memory cache also get replicated to other database nodes. Thus subsequent queries can use the new triple when, for example, another RDFE performs an RDF transaction, or when a database client requests a SQL query against the same table. To ensure that such replicated updates are communicated in a manner that does not create intermediate or otherwise invalid database states at each database node, the platform layer provides Atomicity, Consistency, Isolation and Durability properties, and implements multi-version concurrency control (MVCC) through a transaction management module. In operation, this means that database nodes (including an RDFE) can have a partial or intermediate set of changes within their memory cache (e.g., caused by performance of an on-going transaction), but those partial or intermediate changes stay invisible until a commit from the platform layer finalizes those changes. Thus database clients (including the RDFE) “see” only a consistent and valid version of the database. In the same way, changes made to the distributed database by other database nodes get replicated to the RDFE, and more particularly, to the database objects within its memory cache, but remain invisible until committed.

A number of benefits and advantages of the RDFE will be apparent in light of the present disclosure. For example, a distributed database system configured in accordance with an embodiment can include tables having hundreds of millions, or trillions of triples and allow the RDFE to efficiently perform RDF transactions against that data without necessarily using complex SQL statements. The distributed database system implements ACID properties and implements MVCC using a durable distributed cache, and thus the RDFE “sees” a transactionally-coherent view of the database even while other database nodes concurrently perform RDF or SQL transactions, or both. This means that concurrent transactions can occur in parallel without necessarily interrupting on-going database operations. In addition, a user application can instantiate the RDFE and essentially operate as a transaction engine within the distributed database system, and advantageously utilize low-level, internal platform functionality within the distributed database system. Any number of user applications can implement the RDFE and perform RDF transactions against a database. Likewise, an application server can include a process instantiating the RDFE that can service remote RDF requests such as SPARQL queries.

Architecture and Operation

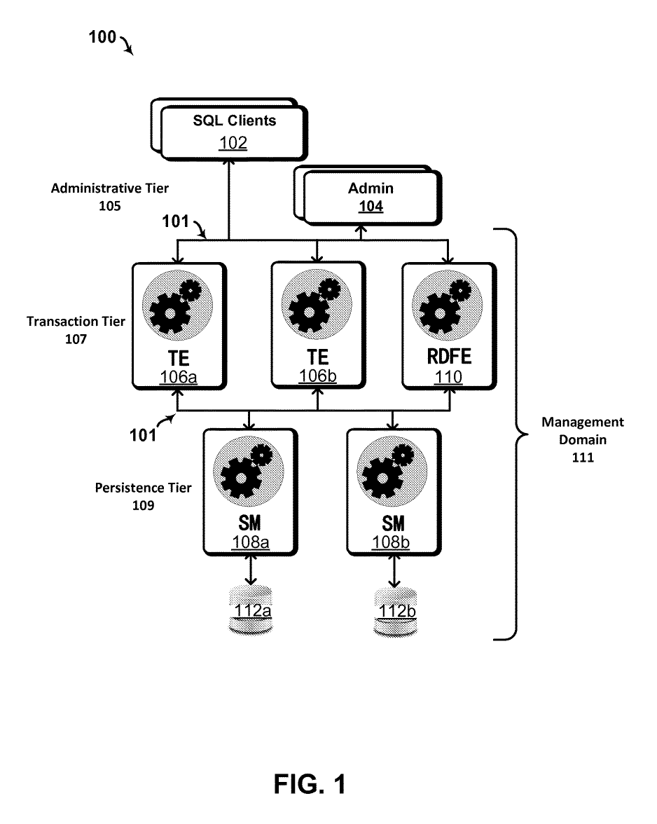

Referring now to the figures, FIG. 1 illustrates an example distributed database system 100 comprising interconnected nodes configured to persist RDF triples in relational tables, in accordance with an embodiment of the present disclosure. As shown in the example embodiment, the architecture of the distributed database system 100 includes a number of database nodes assigned to three logical tiers: an administrative tier 105, a transaction tier 107, and a persistence tier 109. The nodes comprising the distributed database system 100 are peer nodes that can communicate directly and securely with each other to coordinate ongoing database operations. So, as long as at least one database node is operational within each of the transaction tier 107 and the persistence tier 109, SQL clients 102 can connect and perform transactions against databases hosted within the distributed database system 100.

In more detail, the distributed database system 100 is an elastically-scalable database system comprising an arbitrary number of database nodes (e.g., nodes 104, 106a-b, 108a-b and 110) executed on an arbitrary number of host computers (not shown). For example, database nodes can be added and removed at any point on-the-fly, with the distributed database system 100 using newly added nodes to “scale out” or otherwise increase database performance and transactional throughput. As will be appreciated in light of this disclosure, the distributed database system 100 departs from database approaches that tightly couple on-disk representations of data (e.g., pages) with in-memory structures. Instead, certain embodiments disclosed herein advantageously provide a memory-centric database wherein each peer node implements a memory cache in volatile memory (e.g., random-access memory) that can be utilized to keep active portions of the database cached for efficient updates during ongoing transactions. In addition, database nodes of the persistence tier 109 can implement storage interfaces that can commit those in-memory updates to physical storage devices to make those changes durable (e.g., such that they survive reboots, power loss, application crashes). Such a combination of distributed memory caches and durable storage interfaces is generally referred to herein as a durable distributed cache (DDC).

In an embodiment, database nodes can request portions of the database residing in a peer node's memory cache, if available, to avoid the expense of disk reads to retrieve portions of the database from durable storage. Examples of durable storage that can be used in this regard include a hard drive, a network attached storage device (NAS), a redundant array of independent disks (RAID), and any other suitable storage device. As will be appreciated in light of this disclosure, the distributed database system 100 enables the SQL clients 102 to view what appears to be a single, logical database with no single point of failure, and perform transactions that advantageously keep in-use portions of the database in memory cache (e.g., volatile random-access-memory (RAM)) while providing (ACID) properties.

The SQL clients 102 can be implemented as, for example, any application or process that is configured to construct and execute SQL queries. For instance, the SQL clients 102 can be user applications implementing various database drivers and/or adapters including, for example, java database connectivity (JDBC), open database connectivity (ODBC), PHP data objects (PDO), or any other database driver that is configured to communicate and utilize data from a relational database. As discussed above, the SQL clients 102 can view the distributed database system 100 as a single, logical database. To this end, the SQL clients 102 address what appears to be a single database host (e.g., utilizing a single hostname or internet protocol (IP) address), without regard for how many database nodes comprise the distributed database system 100.

Within the transaction tier 107 a plurality of TE nodes 106a-106b is shown. The transaction tier 107 can comprise more or fewer TE nodes, depending on the application, and the number shown should not be viewed as limiting the present disclosure. As discussed further below, each TE node can accept SQL client connections from the SQL clients 102 and concurrently perform transactions against the database within the distributed database system 100. In principle, the SQL clients 102 can access any of the TE nodes to perform database queries and transactions. However, and as discussed below, the SQL clients 102 can advantageously select those TE nodes that provide a low-latency connection through an agent node running as a “connection broker”, as will be described in turn.

Also shown within the transaction tier 107, an RDFE node 110 is shown. The RDFE node 110 can service RDF requests by, for example, an application instantiating the RDFE, or through hosting an RDF-enabled endpoint (e.g., a SPARQL endpoint), or both. In a sense, the RDFE operates as a TE node and thus can perform database modifications within transactions, and also can concurrently perform transactions against the database within the distributed database system 100. Further aspects of the RDFE node 110, and its architecture, are discussed below.

Within the persistence tier 109 a SM nodes 108a and 108b are shown. In an embodiment, each of the SM nodes 108a and 108b include a full archive of the database within a durable storage location 112a and 112b, respectively. Note, however, in an embodiment each SM node can persist a portion of the database. For example, the distributed database system 100 can divide tables into table partitions and implement rules, also referred to herein as partitioning policies, which govern the particular subset of SM nodes that store and service a given table partition. In addition, the table partitioning policies can define criteria that determine in which table partition a record is stored. So, the distributed database system can synchronize database changes in a manner that directs or otherwise targets updates to a specific subset of database nodes when partitioning polices are in effect. Within the context of RDF triple-store tables, such partitioning can be advantageous as the distributed database system 100 can target a subset of SM nodes to persist large triple-store tables, instead of each SM node potentially having a copy of every table. In some such example embodiments, table partitioning is implemented as described in co-pending U.S. patent application Ser. No. 14/725,916, filed May 29, 2015 and titled “Table Partitioning within Distributed Database Systems” which is herein incorporated by reference in its entirety. Thus, while example scenarios provided herein assume that the distributed database system 100 does not have active table partitioning policies, scenarios having active table partitioning policies will be equally apparent and are intended to fall within the scope of this disclosure.

In an embodiment, the durable storage locations 112a and 112b can be local (e.g., within the same host computer) to the SM nodes 108a and 108b. For example, the durable storage locations 112a and 112b can be implemented as a physical storage device such as a spinning hard drive, solid-state hard drive, or a raid array comprising a plurality of physical storage devices. In other cases, the durable storage locations 112a and 112b can be implemented as, for example, network locations (e.g., network-attached storage (NAS)) or other suitable remote storage devices and/or appliances, as will be apparent in light of this disclosure.

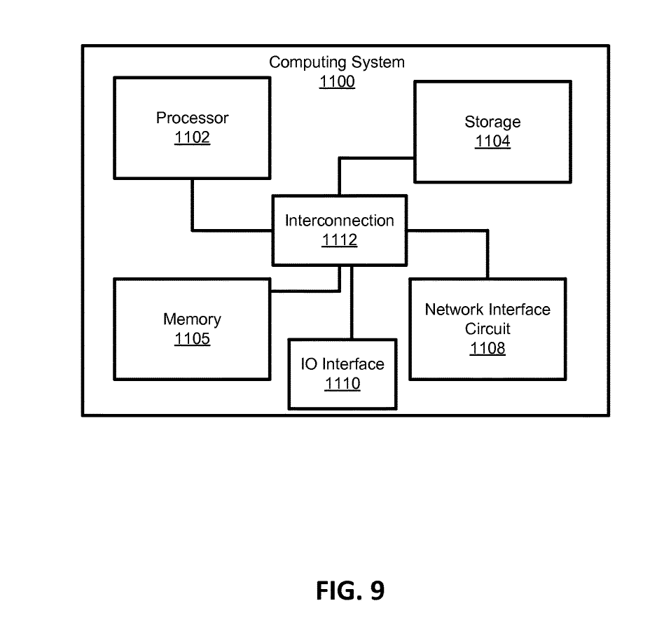

In an embodiment, each database node (admin node 104, TE nodes 106a-106b, RDFE node 110, and SM nodes 108a-b) of the distributed database system 100 can comprise a computer program product including machine-readable instructions compiled from C, C++, Java, Python or other suitable programming languages. These instructions may be stored on a non-transitory computer-readable medium, such as in a memory of a given host computer, and when executed cause a given database node instance to be instantiated and executed. As discussed below, an admin node 104 can cause such instantiation and execution of database nodes by causing a processor to execute instructions corresponding to a given database node. One such computing system 1100 capable of instantiating and executing database nodes of the distributed database system 100 is discussed below with regard to FIG. 9.

In an embodiment, the database nodes of each of the administrative tier 105, the transaction tier 107, and the persistence tier 109 are communicatively coupled through one or more communication networks 101. In an embodiment, such communication networks 101 can be implemented as, for example, a physical or wireless communication network that enables data exchanges (e.g., packets) between two points (e.g., nodes running on a host computer) utilizing one or more data transport protocols. Some such example protocols include transmission control protocol (TCP), user datagram protocol (UDP), shared memory, pipes or any other suitable communication means that will be apparent in light of this disclosure. In some cases, the SQL clients 102 access the various database nodes of the distributed database system 100 through a wide area network (WAN) facing internet protocol (IP) address. In addition, as each database node within the distributed database system 100 could be located virtually anywhere where there is network connectivity, and encrypted point-to-point connections (e.g., virtual private network (VPN)) or other suitable secure connection types may be established between database nodes.

Management Domains

As shown, the administrative tier 105 includes at least one admin node 104 that is configured to manage database configurations, and is executed on computer systems that will host database resources. Thus, and in accordance with an embodiment, the execution of an admin node 104 is a provisioning step that both makes the host computer available to run database nodes, and makes the host computer visible to distributed database system 100. A collection of these provisioned host computers is generally referred to herein as a management domain. Each management domain is a logical boundary that defines a pool of resources available to run databases, and contains permissions for users to manage or otherwise access those database resources. For instance, and as shown in FIG. 1, the distributed database system 100 includes one such management domain 111 that encompasses the database nodes of the distributed database system 100, and the one or more respective host computers (not shown) executing those database nodes.

For a given management domain, an admin node 104 running on each of the host computers is responsible for starting and stopping a database, monitoring those nodes and the host's computers resources, and performing other host-local tasks. In addition, each admin node 104 enables new database nodes to be executed to, for example, increase transaction throughput and/or to increase the number of storage locations available within the distributed database system 100. This enables the distributed database system 100 to be highly elastic as new host computers and/or database nodes can be added in an on-demand manner to meet changing database demands and decrease latencies. For example, database nodes can be added and executed on-the-fly during runtime (e.g., during ongoing database operations), and those database nodes can automatically authenticate with their peer nodes in order to perform secure point-to-point communication within the management domain 111.

In an embodiment, the admin node 104 can be further configured to operate as a connection broker. The connection broker role enables a global view of all admin nodes in a management domain, and thus all database nodes, databases and events (e.g., diagnostic, error related, informational) therein. In addition, the connection broker role enables load-balancing between the SQL clients 102 and the TE nodes 106a-106b. For example, the SQL clients 102 can connect to a particular admin node configured as a connection broker in order to receive an identifier of a TE node (e.g., an IP address, host name, alias, or logical identifier) that can service connections and execute transactions with a relatively low latency compared to other TE nodes. In an embodiment, load-balancing policies are configurable, and can be utilized to optimize connectivity based on factors such as, for example, resource utilization and/or locality (e.g., with a preference for those TE nodes geographically closest to a SQL client, or those TE nodes with the fastest response time).

Transaction Engine Architecture

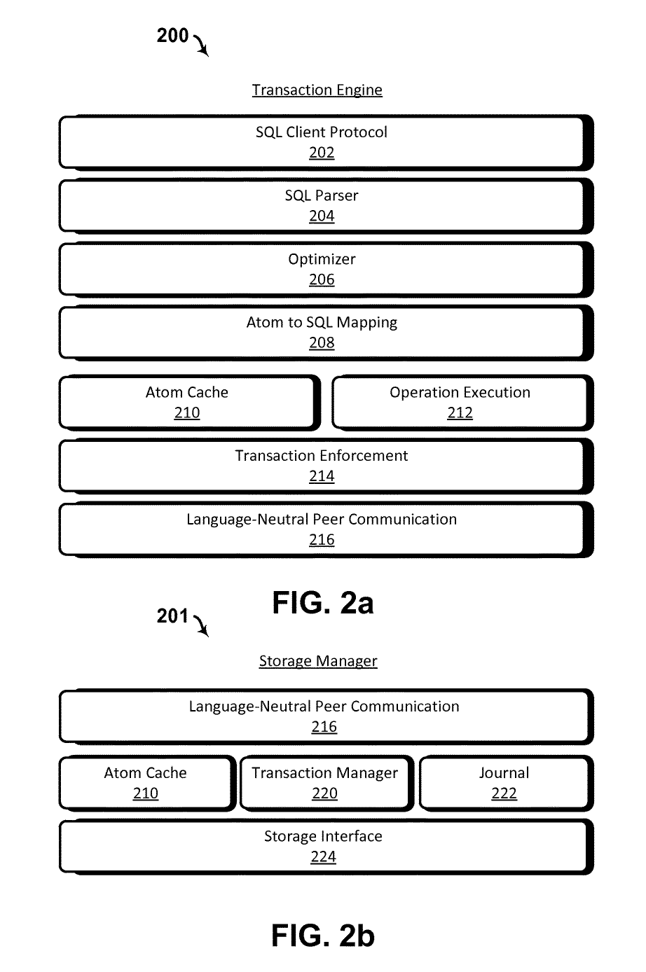

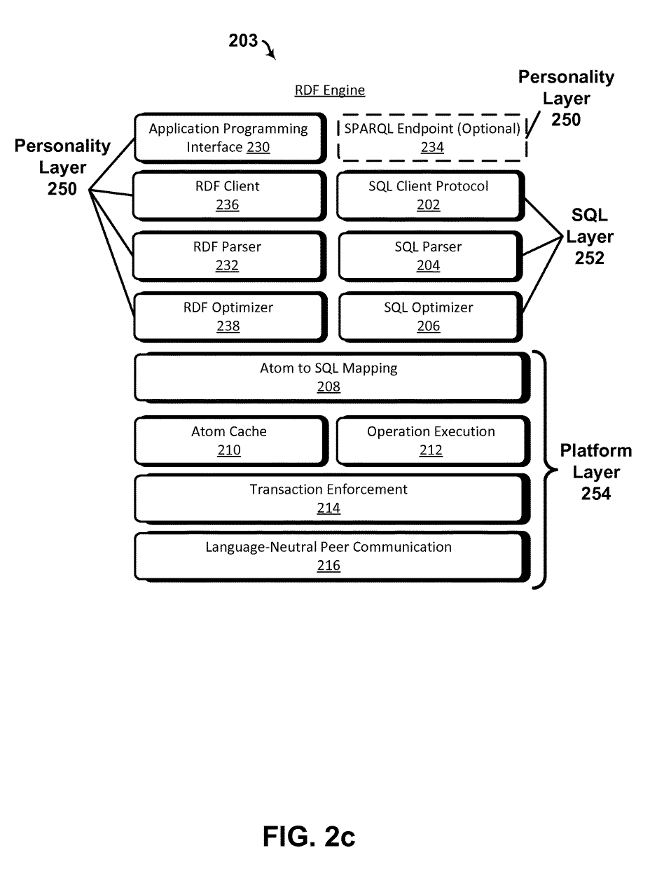

FIG. 2a depicts one example of the architecture 200 of the TE nodes (e.g., TE nodes 106a-106b) within the distributed database system 100, in accordance with an embodiment of the present disclosure. As discussed above, TE nodes are client-facing database nodes that accept connections from the SQL clients 102 and enable a single, logical view of a database across a plurality of database nodes within the management domain 111. Accordingly, and as shown, the TE architecture 200 includes a SQL client protocol module 202, a SQL parser 204, and a SQL optimizer 206. Such SQL-based modules can be accurately referred to a personality. As will be appreciated in light of this disclosure, this SQL-based personality can be used either alone (e.g., to perform SQL queries requested by a database client) or in conjunction with other personalities implemented within a given TE node or other such node implementing the same such as the RDFE architecture 203 discussed below.

In an embodiment, the SQL client protocol module 202 can be configured to host remote connections (e.g., through UDP/TCP) and receive packets (or data structures via shared memory/pipes) from SQL clients 102 to execute SQL transactions. The SQL parser module 204 is configured to receive the SQL transactions from the remote connections, and parses those queries to perform various functions including, for example, validating syntax and semantics validation, determining whether adequate permissions exist to execute the statements, and allocating memory and other resources dedicated to the query. In some cases, a transaction can comprise a single operation such as “SELECT,” “UPDATE,” “INSERT,” and “DELETE,” just to name a few. In other cases, each transaction can comprise a number of such operations affecting multiple objects within a database. In these cases, and as will be discussed further below, the distributed database system 100 enables a coordinated approach that ensures these transactions are consistent and do not result in errors or other corruption that can otherwise be caused by concurrent transactions updating the same portions of a database (e.g., performing writes on a same record or other database object simultaneously).

In an embodiment, an optimizer 206 can be configured to determine a preferred way of executing a given query. To this end, the optimizer 206 can utilize indexes, and table relationships to avoid expensive full-table scans and to utilize portions of the database within memory cache when possible.

As shown, the example TE architecture 200 includes an atom to SQL mapping module 208. The atom to SQL mapping module 208 can be utilized to locate atoms that correspond to portions of the database that are relevant or otherwise affected by a particular transaction being performed. As generally referred to herein, the term “atom” refers to a flexible data object or structure that contains a current version and a number of historical versions for a particular type of database object (e.g., schema, tables, rows, data, blobs, and indexes). Within TE nodes, atoms generally exist in non-persistent memory, such as in an atom cache module, and can be serialized and de-serialized, as appropriate, to facilitate communication of the same between database nodes. As will be discussed further below with regard to FIG. 2b, atom updates can be committed to durable storage by SM nodes. So, atoms can be marshalled or un-marshaled by SMs utilizing durable storage to service requests for those atoms by TEs nodes.

It should be appreciated in light of this disclosure an atom is a chunk of data that can represent a database object, but is operationally distinct from a conventional page in a relational database. For example, atoms are, in a sense, peers within the distributed database system 100 and can coordinate between their instances in each atom cache 210, and during marshalling or un-marshalling by the storage interface 224. In addition to database objects, there are also atoms that represent catalogs, in an embodiment. In this embodiment, a catalog can be utilized by the distributed database system 100 to resolve atoms. In a general sense, catalogs operate as a distributed and self-bootstrapping lookup service. Thus, when a TE node starts up, it needs to get just one atom, generally referred to herein as a catalog. This is a root atom from which all other atoms can be found. Atoms link to other atoms, and form chains or associations that can be used to reconstruct database objects stored in one or more atoms. For example, the root atom can be utilized to reconstruct a table for query purposes by locating a particular table atom. In turn, a table atom can reference other related atoms such as, for example, index atoms, record atoms, and data atoms.

In an embodiment, a TE node is responsible for mapping SQL content to corresponding atoms. As generally referred to herein, SQL content comprises database objects such as, for example, tables, indexes and records that may be represented within atoms. In this embodiment, a catalog may be utilized to locate the atoms which are needed to perform a given transaction within the distributed database system 100. Likewise, the optimizer 206 can also utilize such mapping to determine atoms that may be immediately available in the atom cache 210.

Although TE nodes are described herein as comprising SQL-specific modules 202-208, such modules can be understood as plug-and-play translation layers that can be replaced with or otherwise augmented by non-SQL modules having a different dialect or programming language. In addition, modules 202-216 can also be adaptable to needs and requirements of other types of TE engines that do not necessarily service SQL requests. The RDFE discussed below with regard to FIG. 2c is one such example transaction engine that utilizes these modules to service non-SQL operations. As will be appreciated in light of this disclosure, ACID properties are enforced at the atom-level, which enables the distributed database system to execute other non-SQL type concurrent data manipulations while still providing ACID properties.

Continuing with FIG. 2a, the TE architecture 200 includes an atom cache 210. As discussed above with regard to FIG. 1, the atom cache 210 is part of the DDC implemented within the distributed database system 100. To this end, and in accordance with an embodiment of the present disclosure, the atom cache 210 hosts a private memory space in RAM accessible by a given TE node. The size of the atom cache can be user-configurable, or sized to utilize all available memory space on a host computer, depending upon a desired configuration. When a TE first executes, the atom cache 210 is populated with one or more atoms representing a catalog. In an embodiment, the TE utilizes this catalog to satisfy executed transactions, and in particular, to identify and request the atoms within the atom cache 210 of other peer nodes (including peer TEs and SMs). If an atom is unavailable in any atom cache, a request can be sent to an SM within the distributed database system 100 to retrieve the atom from durable storage, and thus make the requested atom available within the atom cache of the SM. So, it should be appreciated in light of this disclosure that the atom cache 210 is an on-demand cache, wherein atoms can be copied from one atom cache to another, as needed. It should be further appreciated that the on-demand nature of the atom cache 210 enables various performance enhancements as a given TE node can quickly and efficiently be brought on-line without the necessity of retrieving a large number of atoms.

Still continuing with FIG. 2a, the TE architecture 200 includes an operation execution module 212. The operation execution module 212 can be utilized to perform in-memory updates to atoms (e.g., data manipulations) within the atom cache 210 based on a given transaction. Once the operation execution module 212 has performed various in-memory updates to atoms, a transaction enforcement module 214 ensures that changes occurring within the context of a given transaction are performed in a manner that provides ACID properties. As discussed above, concurrently-executed transactions can potentially alter the same portions of a database during execution. By way of illustration, consider the sequence of events that occur when money is moved between bank accounts represented by tables and data in a database. During one such example transaction, a subtraction operation decrements money from one record in the database and then adds the amount decremented to another record. This example transaction is then finalized by a commit operation that makes those record changes “durable” or otherwise permanent (e.g., in hard drive or other non-volatile storage area). Now consider if two such transactions are concurrently performed that manipulate data in same portions of the database. Without careful consideration of this circumstance, each transaction could fail before fully completing, or otherwise cause an inconsistency within the database (e.g., money subtracted from one account but not credited to another, incorrect amount debited or added to an account, and other unexpected and undesirable outcomes). This is so because one transaction could alter or otherwise manipulate data causing the other transaction to “see” an invalid or intermediate state of that data. To avoid such isolation and consistency violations in the face of concurrent transactions, and in accordance with an embodiment of the present disclosure, the distributed database system 100 applies ACID properties. These properties can be applied not at a table or row level, but at an atom-level. To this end, concurrency is addressed in a generic way without the distributed database system 100 having specific knowledge that atoms contain SQL structures. Application of the ACID properties within the context of the distributed database system 100 will now be discussed in turn.

Atomicity refers to transactions being completed in a so-called “all or nothing” manner such that if a transaction fails, a database state is left unchanged. Consequently, transactions are indivisible (“atomic”) and fully complete, or fully fail, but never perform partially. This is important in the context of the distributed database system 100, where a transaction not only affects atoms within the atom cache of a given TE node processing the transaction, but all database nodes having a copy of those atoms as well. Note that atom copies are so-called “peers” of an atom as the distributed database system 100 keeps all copies up-to-date (e.g., a database update at one TE node targeting a particular atom gets replicated to all other peer atom instances). As will be discussed below, changes to atoms can be communicated in an asynchronous manner to each database process, with those nodes finalizing updates to their respective atom copies only after the transaction enforcement module 214 of the TE node processing the transaction broadcasts a commit message to all interested database nodes. This also provides consistency, since only valid data is committed to the database when atom updates are finally committed. In addition, isolation is achieved as concurrently executed transactions do not “see” versions of data that are incomplete or otherwise in an intermediate state of change. As discussed further below, durability is provided by SM database nodes, which also receive atom updates during transaction processing by TEs, and finalize those updates to durable storage (e.g., by serializing atoms to a physical storage location) before acknowledging a commit. In accordance with an embodiment, an SM may journal changes before acknowledging a commit, and then serialize atoms to durable storage periodically in batches (e.g., utilizing lazy-write).

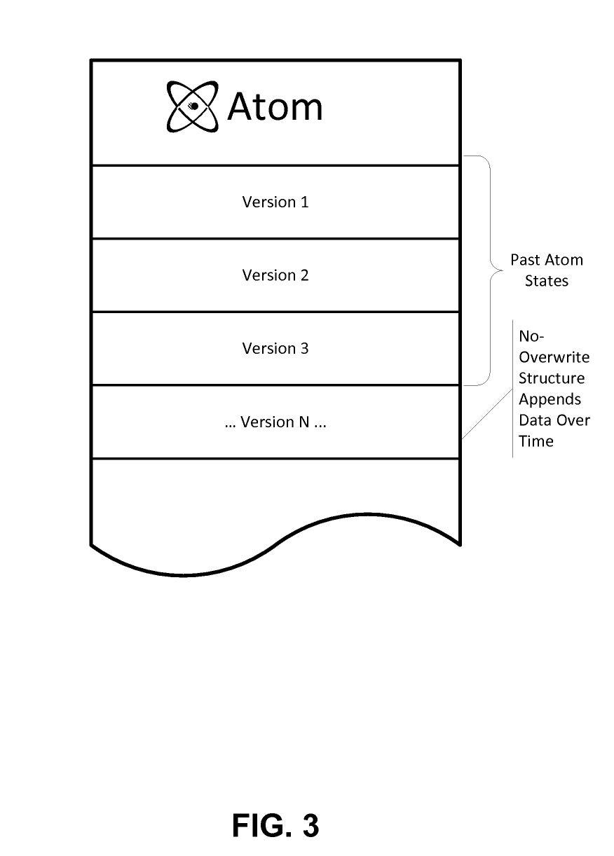

To comply with ACID properties, and to mitigate undesirable delays due to locks during write operations, the transaction enforcement module 214 can be configured to utilize multi-version concurrency control (MVCC). In an embodiment, the transaction enforcement module 214 implements MVCC by allowing several versions of data to exist in a given database simultaneously. This may also be referred to as a no-overwrite scheme or structure as new versions are appended versus necessarily overwriting previous versions. Therefore, an atom cache (and durable storage) can hold multiple versions of database data and metadata used to service ongoing queries to which different versions of data are simultaneously visible. In particular, and with reference to the example atom structure shown in FIG. 3, atoms are objects that can contain a canonical (current) version and a predefined number of pending or otherwise historical versions that may be used by current transactions. To this end, atom versioning is accomplished with respect to versions of data within atoms, and not atoms themselves. Note, a version is considered pending until a corresponding transaction successfully commits. So, the structure and function of atoms enable separate versions to be held in-cache so that no changes occur in-place (e.g., in durable storage); rather, updates can be communicated in a so-called “optimistic” manner as a rollback can be performed by dropping a pending update from an atom cache. In an embodiment, the updates to all interested database nodes that have a peer instance of the same atom in their respective atom cache (or durable storage) can be communicated asynchronously (e.g., via a communication network), and thus, allowing a transaction to proceed with the assumption that a transaction will commit successfully.

Continuing with FIG. 2a, the example TE architecture 200 includes a language-neutral peer communication module 216. In an embodiment, the language-neutral peer communication module 216 is configured to send and receive low-level messages amongst peer nodes within the distributed database system 100. These messages are responsible for, among other things, requesting atoms, broadcasting replication messages, committing transactions, and other database-related messages. As generally referred to herein, language-neutral denotes a generic textual or binary-based protocol that can be utilized between database nodes that is not necessarily SQL. To this end, while the SQL client protocol module 202 is configured to receive SQL-based messages via communication network 101, the protocol utilized between admin nodes, TE nodes, and SM nodes using the communication network 101 can be a different protocol and format, as will be apparent in light of this disclosure.

Storage Manager Architecture

FIG. 2b depicts one example of the architecture 201 of the SMs (e.g., SM node 108a and 108b) within the distributed database system 100, in accordance with an embodiment of the present disclosure. Each SM node is configured to address its own full archive of a database within the distributed database system 100, or a portion thereof depending on active partitioning policies. As discussed above, each database within the distributed database system 100 persists essentially as a plurality of atom objects (e.g., versus pages or other memory-aligned structures). Thus, to adhere to ACID properties, SM nodes can store atom updates to durable storage once transactions are committed. ACID calls for durability of data such that once a transaction has been committed, that data permanently persists in durable storage until otherwise affirmatively removed. To this end, the SM nodes receive atom updates from TE nodes (e.g., TE nodes 106a and 106b) and RDFE nodes performing transactions, and commit those transactions in a manner that utilizes, for example, MVCC as discussed above with regard to FIG. 2a. So, as will be apparent in light of this disclosure, SM nodes function similarly to TE and RDFE nodes as they can perform in-memory updates of atoms within their respective local atom caches; however, SM nodes eventually write such modified atoms to durable storage. In addition, each SM node can be configured to receive and service atom request messages from peer database nodes within the distributed database system 100.

In some cases, atom requests can be serviced by returning requested atoms from the atom cache of an SM node. However, and in accordance with an embodiment, a requested atom may not be available in a given SM node's atom cache. Such circumstances are generally referred to herein as “misses” as there is a slight performance penalty because durable storage must be accessed by an SM node to retrieve those atoms, load them into the local atom cache, and provide those atoms to the database node requesting those atoms. For example, a miss can be experienced by a TE node, a RDFE node, or SM node when it attempts to access an atom in its respective cache and that atom is not present. In this example, a TE or RDFE node responds to a miss by requesting that missing atom from another peer node (e.g., a RDFE node, a TE node, or an SM node). To this end, a database node incurs some performance penalty for a miss. Note that in some cases there may be two misses. For instance, a TE node may miss and request an atom from an SM node, and in turn, the SM node may miss (e.g., the requested atom is not in the SM node's atom cache) and load the requested atom from disk.

As shown, the example SM architecture 201 includes modules that are similar to those described above with regard to the example TE architecture 200 of FIG. 2a (e.g., the language-neutral peer communication module 216, and the atom cache 210). It should be appreciated that these shared modules are adaptable to the needs and requirements of the particular logical tier to which a node belongs, and thus, can be utilized in a generic or so-called “plug-and-play” fashion by both transactional (e.g., TE nodes and RDFE nodes) and persistence-related database nodes (e.g., SM nodes). However, and in accordance with the shown embodiment, the example SM architecture also includes additional persistence-centric modules including a transaction manager module 220, a journal module 222, and a storage interface 224. Each of these persistence-centric modules will now be discussed in turn.

As discussed above, a SM node is responsible for addressing a full archive of one or more databases within the distributed database system 100, or a portion thereof depending on active partitioning policies. To this end, the SM node receives atom updates during transactions occurring on one or more nodes (e.g., TE nodes 106a and 106b, and RDFE node 110) and is tasked with ensuring that the updates in a commit are made durable prior to acknowledging that commit to an originating node, assuming that transaction successfully completes. As all database-related data is represented by atoms, so too are transactions within the distributed database system 100, in accordance with an embodiment. To this end, the transaction manager module 220 can store transaction atoms within durable storage. As will be appreciated, this enables SM nodes to logically store multiple versions of data-related atoms (e.g., record atoms, data atoms, blob atoms) and perform so-called “visibility” routines to determine the current version of data that is visible within a particular atom, and consequently, an overall current database state that is visible to a transaction performed on a TE node. In addition, and in accordance with an embodiment, the journal module 222 enables atom updates to be journaled to enforce durability of the SM node. The journal module 222 can be implemented as an append-only set of diffs that enable changes to be written efficiently to the journal.

As shown, the example SM architecture 201 also includes a storage interface module 224. The storage interface module 224 enables a SM node to write and read from durable storage that is either local or remote to the SM node. While the exact type of durable storage (e.g., local hard drive, RAID, NAS storage, cloud storage) is not particularly relevant to this disclosure, it should be appreciated that each SM node within the distributed database system 100 can utilize a different storage service. For instance, a first SM node can utilize, for example, a remote Amazon Elastic Block Store (EBS) volume while a second SM node can utilize, for example, an Amazon S3 service. Thus, such mixed-mode storage can provide two or more storage locations with one favoring performance over durability, and vice-versa. To this end, and in accordance with an embodiment, TE nodes and SM nodes can run cost functions to track responsiveness of their peer nodes. In this embodiment, when a node needs an atom from durable storage (e.g., due to a “miss”) the latencies related to durable storage access can be one of the factors when determining which SM node to utilize to service a request.

In some embodiments the persistence tier 109 includes a snapshot storage manager (SSM) node that is configured to capture and store logical snapshots of the database in durable memory. In some example embodiments, the SSM node is implemented as described in U.S. patent application Ser. No. 14/688,396, filed Apr. 15, 2015 and titled “Backup and Restore in a Distributed Database Utilizing Consistent Database Snapshots” which is herein incorporated by reference in its entirety.

RDF Engine Architecture

FIG. 2c depicts one example of the architecture 203 of an RDFE node (e.g., RDFE node 110) within the distributed database system 100, in accordance with an embodiment of the present disclosure. As shown, the RDFE architecture is substantially similar to that of a TE node discussed above with regard to FIG. 2a, but with additional modules that comprise a personality layer 250. While the SQL modules 202-206 are, in a sense, also a personality, the following description considers them part of a SQL layer 252 for clarity. Recall that the modules within the SQL layer 252 and the platform layer 254 (e.g., modules 202-216) can be “plug-and-play” and adaptable to the operational requirements of the RDFE. Thus the personality layer can use the SQL layer modules to perform RDF operations against the database when needed, but can also directly interface with platform layer modules 254 to increase query and update performance.

In more detail, the example architecture 203 includes a personality layer 250 including an API module 230, an RDF parser 232, an optional SPARQL endpoint 234, an RDF client 236, and an RDF optimizer 238. In a general sense, modules of the personality layer 250 enables serving of RDF triples in the form of directed graphs, and allows users to add, remove, and store that information. In RDF data models both the resources being described and the values describing them are nodes in a directed labeled graph (directed graph). The arcs (or lines) connecting pairs of nodes correspond to the names of the property types. So a collection of triples is considered a directed graph, wherein the resources and literals represented by the triples' subjects and objects are nodes, and the triples' predicates are the vertices connecting them. One such example directed graph 402 is depicted in FIG. 4. A graph can persist in a single table, or a set of tables, depending on a desired configuration. So, the modules within the personality layer 250 allow for adding and removing of triples to graphs and locating triples that match search patterns.

In an embodiment, modules of the personality layer 250 can be implemented, in part, using the Apache Jena Architecture. The Jena Architecture is a Java framework for building Semantic Web Applications and provides tools and libraries to develop Semantic Web and linked-data applications. For example, the API module 230 can comprise Jena-specific function definitions and services. In addition, the RDF client 236 and the RDF parser 232 can comprise Jena-based libraries and tools for translating RDF queries into constituent parts. However, a custom or proprietary implementation can be utilized, and this disclosure should not be construed as limited to just Jena-based components to perform RDF processing.

In an embodiment, the RDF client 236 functions similarly to the SQL client protocol 202 in that it processes queries constructed by clients and prepares those queries for execution by using an appropriate parser. When an RDF query is received from the API 230, or the SPARQL endpoint 234, the RDF client 236 processes the received RDF query and constructs a representation of that query for processing by the RDF parser 232. So, regardless of how the RDF query is received (e.g., by the API 230, or the SPARQL endpoint 234), the RDFE constructs an execution plan for that query. The RDF Optimizer 238 allows that plan to be manipulated in order to reduce I/O costs and execution time of a given query. During simple queries, such as those with a single search pattern, RDF optimization can include favoring an execution plan that minimizes use of full URIs in favor of internal identifiers. Stated differently, using internal identifiers enables atoms to be located and accessed efficiently without requiring additional translation by accessing mapping tables within the database (e.g., URI to internal identifier mappings). In operation, this may include the RDF optimizer 238 replacing one or more blocks of an execution plan with alternative blocks that reduce URI to internal identifier translations, and thus allows a more direct and efficient interrogation of an atom cache to locate those atoms affected by a given RDF query.

During complex queries, such as those with two or more search patterns, the RDF optimizer 238 can rearrange RDF queries such that search patterns get organized into a sequence that reduces query execution time. By way of illustration, consider the following example RDF query:

?person myNs:hasName ?name.
?person rdf:is myNs:teacher
The first search pattern extracts from the database all the persons and their names to bind the ?person and ?name variables. Then the second search pattern verifies each of those ?person variables are a “teacher” by checking, for each located ?person variable, the existence of a triple having a the same ?person as a subject, the rdf:is as a predicate, and the myNs:teacher URI as an object. A more efficient version of the same example query is:
?person rdf:is myNs:teacher.
?person myNs:hasName ?name
This example query represents one alternative the RDF Optimizer can identify that consequently results in the use of a smaller dataset than the original query. For example, the first search pattern extracts from the database only the teachers, rather than the entire list of persons of the school. For each of those located person variables, the second search pattern extracts the triples having the same ?person as a subject, and the same myNs:hasName as the predicate, with the object of those matching triples assigned to the ?name variable.

Thus the RDF optimizer 238 can look at each possible order of execution, determine an estimate of the number of triples returned by each subquery and thus calculate an expected total cost of that execution order. So, using these estimations, the RDF optimizer 238 can modify the original search patterns, and by extension the execution plan, such that one or more blocks of the execution plan get replaced to avoid using full URIs where appropriate. In addition, the RDF optimizer 238 can alter the sequence of search patterns such that they are ordered in a manner that reduces overall query costs.

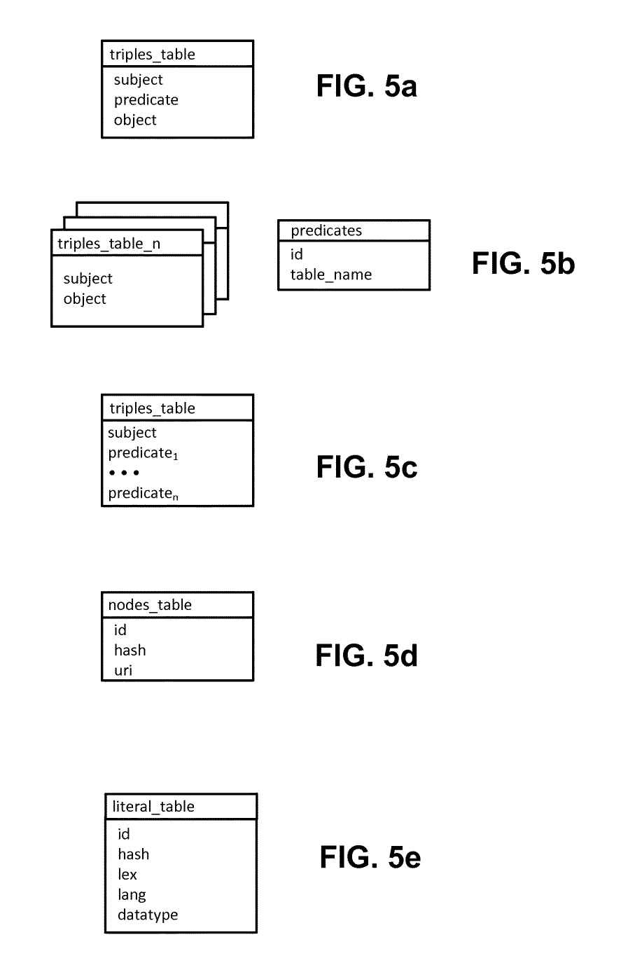

In any event, triples can be stored in relational tables and the modules of the personality layer 250 (e.g., RDF-based modules 230-238) can access those tables and associated indexes during RDF query processing. The schema chosen for those tables is also important for optimizing RDF queries, and some specific example schema implementations are discussed below with regard to FIGS. 5a-5e.

Continuing with FIG. 2c, the example architecture 203 can include an optional SPARQL endpoint module 234. In an embodiment, the SPARQL endpoint module can comprise a Fuseki-based service. Fuseki is a SPARQL server and is also a member of the Jena Architecture. In other embodiments, a different SPARQL server could be implemented (e.g., a proprietary one, or an open-source alternative) and this disclosure should not be construed as limiting in this regard. In any such cases, the SPARQL endpoint module 234 can service SPARQL requests including at least one of a representational state transfer (REST)-style SPARQL HTTP update, SPARQL Query, and SPARQL updates using the SPARQL protocol over HTTP, just to name a few.

Examples and embodiments discussed herein include specific reference to an RDF-based personality for such non-SQL queries, but this disclosure is not limited in this regard. For example, the personality layer can comprise different parser nodes such as a JSON parser, and a JSON endpoint. In addition, the personality layer can comprise multiple such “personalities” and allow multiple types of non-SQL queries based on user input through the API module 230, or through an endpoint module servicing remote requests, or both. For example, an RDFE node can include a JSON and RDF personality to service concurrent queries in either format.

Now referring to FIG. 4, a block diagram depicts one example embodiment 100′ of the distributed database system 100 of FIG. 1 configured to service RDF queries using the RDFE node 110, in accordance with an embodiment of the present disclosure. As should be appreciated, the example embodiment 100′ shown in FIG. 4 is an abbreviated view of the distributed database system 100, and to this end, database nodes (e.g., TE nodes 106a and 106b, SM nodes 108a and 108b) have been excluded merely for clarity and ease of description. Further, it should be appreciated that the distributed database system 100 can comprise a plurality of RDFE nodes 110 and this disclosure it not limited to only the number shown.

As shown, the example embodiment of FIG. 4 includes the RDFE node 110 communicatively coupled to the durable distributed cache 404. As discussed above, a database node that implements the atom cache 210 can store active portions of the database in their respective memory cache, in addition to synchronizing updates to those active portions with all other database nodes within the distributed database system 100. To this end, durable distributed cache 404 represents the local memory cache as well as the memory caches of all other database nodes and durable storage locations. Recall that database objects (e.g., tables, indexes, records, and so on) can be represented by atoms within the distributed database system 100. Thus tables holding RDF triples can also be represented by atoms within the durable distributed cache 404.

Triple-Store Table Layouts

In more detail, the distributed database system 100 can persist RDF triples in relational tables having different schema. Some specific example schemas will now be discussed in turn. Now referring to FIG. 5a, one example triple-store schema is shown. The table includes three columns: subject, predicate and column. These columns comprise a three-part unique key for the table, with each record in the table representing a single triple. This approach can accurately be described as a pure column store. A pure column store means that the data is stored and compressed in column-wise fashion and individual columns can be accessed separately from other columns. Indexes for the table can include, for example, predicate-object, object-subject. Note, the table can also include a “graph” column to enable a so-called “quad store” that can store multiple directed graphs in a single table.

Thus the RDFE node 110 can use a small number of indexes to cover each query case. Advantageous of this approach include simplicity as it is not necessary to change the structure of the table as graph schema evolves because of the insertion of new triples. However, as previously discussed, a large number of self-joins can be necessary to service a query against this table, and thus, optimization against this schema can pose a challenge. In addition, index statistics grow as the record count grows, and thus, can increase latencies associated with preparing and executing an optimized query plan.

Now referring to FIG. 5b, an example triple-store schema is shown in a so-called “predicate table layout”. As shown, this approach includes decomposing triples into two-column tables representing subject and object, wherein each table represents a single predicate. Using this approach there are fewer indices to compute per-table, but consequently, the number of total indices grows as new predicates get added. In addition, the predicate layout table example shown in FIG. 5b can include an associated table called “predicates” that maps internal identifiers to the name of a particular table storing triples with that predicate. Queries against these tables utilize cross-table joins, which are less costly then the joins performed against the table layout approach of FIG. 5a discussed above.

Now referring to FIG. 5c, an example schema is shown that utilizes a single database table where a first column is the subject and every other column names a predicate. The table inserts additional predicates by adding columns. Thus, the table becomes sparse as additional predicates get inserted because each row populates only the subject column and a single predicate column with the remaining columns having a NULL or otherwise undefined value. To this end, the number of indices for the table can become large and result in query latencies.

In an embodiment, the schema approaches of FIGS. 5a-5c can be combined and utilized in a hybrid mode. For example, the distribute database system 100 can use the predicate-table approach of FIG. 5b in combination with the single-table approach of FIG. 5c. More particularly, the distributed database system 100 can use a table with multiple predicate columns, and later move some predicates to their own tables. Other such combinations will be apparent in light of this disclosure.

FIG. 5d depicts one example node table used to store the representation of RDF terms. More specifically, RDF queries can reference a URI (e.g., a URL) of a resource (e.g., a subject, predicate, or object) as part of the query constraints. Recall that a machine parsing such a query looks to find meaning for each element of a triple, and URIs can provide that information. Thus an RDFE node can perform this translation by, for example, looking up the URI in the nodes table to find a corresponding internal identifier. The nodes table can also be referred to as a dictionary or mapping table. The RDFE can use this mapping during data loading and when translating terms in an RDF query to an internal identifier. Therefore, each subject, predicate and object column of the example table layouts shown in FIG. 5a-5c can reference identifiers stored within the nodes table. Thus, records in a triple-store table can include a small amount of information (e.g., an integer value for the subject, object and predicate), and advantageously reference entries in the node table to provide further resource semantics.

Note that subject and object columns can also reference a literal value. That is, the triple-store tables can store un-typed information often in the form of a Unicode string. To this end, the internal identifiers within each of the example table layouts shown in FIG. 5a-5c can alternatively reference an identifier stored in a the literal table shown in FIG. 5e. To distinguish between those identifiers stored in the nodes table versus the literal table, the distributed database can implement a globally unique identification scheme. For example, the distributed database system can reserve a particular range of identifiers for records stored in the nodes table and a different range of identifiers for records stored in the literal table. Thus, the RDFE node can efficiently determine if a subject or object referenced in a triple-store table is a literal or URI value by a simple comparison operation on the ID value. As discussed below, this enables the RDFE node to traverse a B-tree index object and quickly identify if the partial keys within each key-value pair identify a URI or a literal.

In more detail, the literal table can include an ID column as discussed above, a hash column (e.g., a 128 bit MD5 hash, or a 64 bit hash, or other applicable hash algorithm), a lexical identifier column, a language identifier column, and a datatype column.

Returning to FIG. 4, the example directed graph 402 can persist within the durable distributed cache 404 using, for example, one of the layout schemas discussed above with regard to FIGS. 5a-5e. In one specific example, the distributed database system 100 can store the directed graph 402 in a predicate-layout format as discussed above with regard to FIG. 5b. In this example, the distributed database system 100 includes a predicate table for “is-a” and a predicate table for “is-named.” Within the predicate table “is a”, a record exists with the internal identifier equal to 12345. Likewise, within the predicate table “is-named”, a record exists with the internal identifier equal to 823324. Stated differently, the first predicate table includes a record with the subject-object pair that forms the triple “NuoDB, Inc. is-a Corporation.” The other predicate table includes a record with the subject-object pair that forms the triple “NuoDB, Inc. is-named ‘NuoDB’”.

Thus when the RDFE node 110 receives an RDF query from a user application, or from a remote client via the SPARQL endpoint 234, the RDFE node 110 can execute that query against the directed graph 402. Some such queries can include, for example, a request for each resource that “is-a” Corporation. In this example, the RDFE locates the NuoDB, Inc. resource and can return its identifier within a result set. A subsequent query could be, for example, a request for the name of the resource identified in the result set of the previous request (e.g., ID=1). In this instance, the RDFE query can search the predicate table “is named” to locate an object with an identifier of 1, and can return a result set with the corresponding literal value of “NuoDB”. These example queries are provided merely for illustration and should not be viewed as limiting the present disclosure. In addition, the directed graph 402 should not be viewed as limiting as the distribute database system 100 can include multiple directed graphs persisted in one or more tables.

Methods

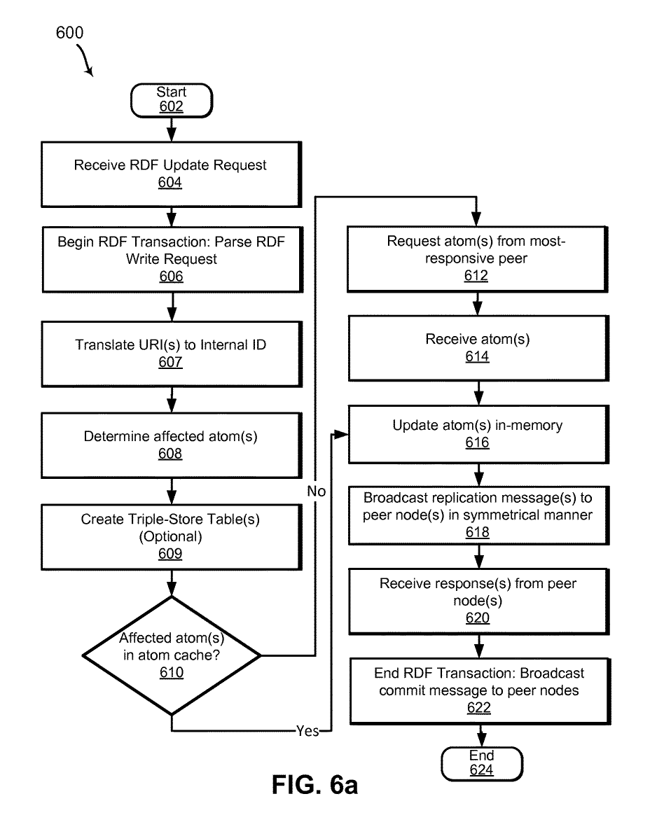

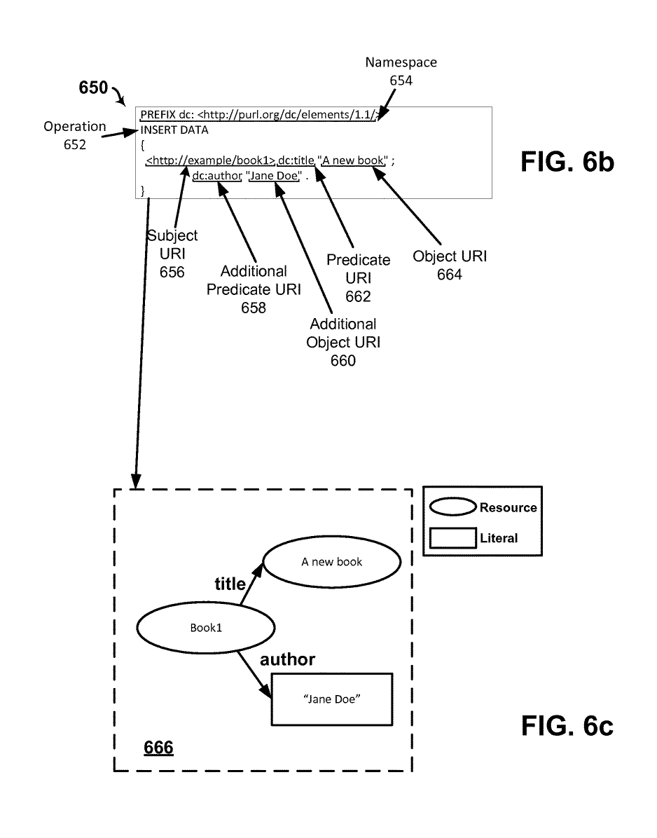

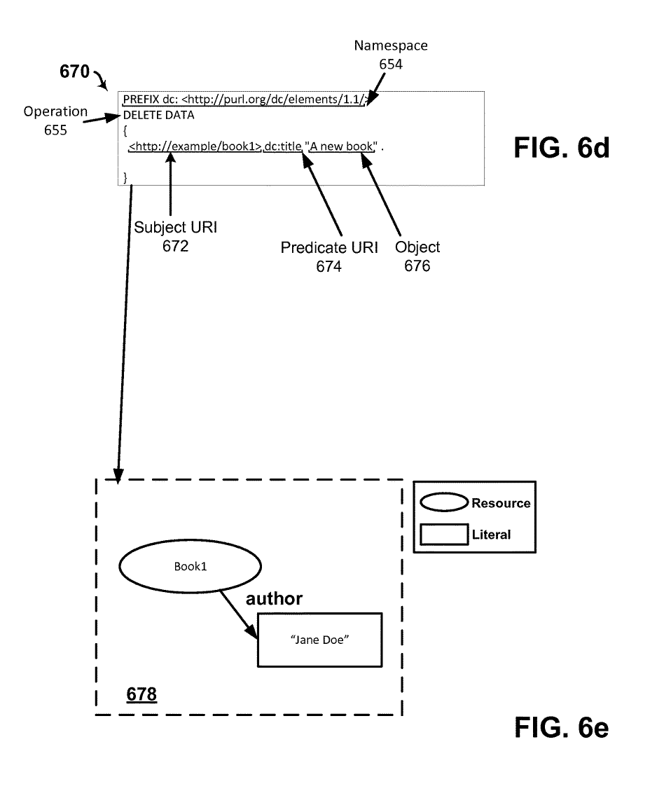

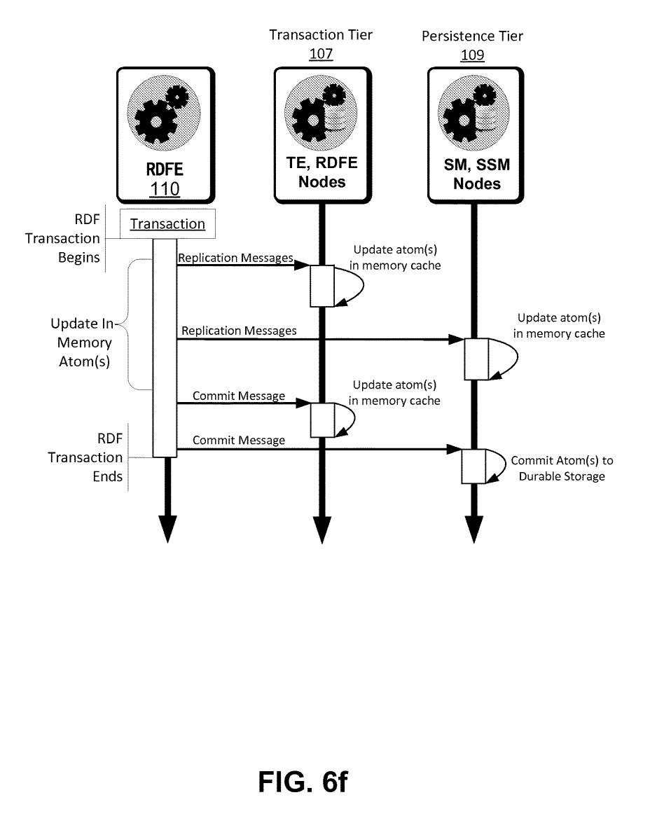

Referring now to FIG. 6a, a flowchart is shown illustrating an example method 600 for processing an RDF update request. Method 600 may be implemented, for example, by the distributed database system 100 of FIG. 1, and more particularly by an RDFE node. Method 600 begins in act 602.

In act 604, the RDFE node receives an RDF update request. In some cases, the RDFE node receives the update request from an application that instantiated the RDFE node. For instance, the user application may execute a function of the API module 230 or otherwise instruct the RDFE to perform an update operation. In other cases, the RDFE receives the update request from a remote client via a SPARQL endpoint, such as the SPARQL endpoint 234.

In act 606, the RDFE node begins an RDF transaction and parses the update request received in act 604. Recall that transactions “see” a consistent version of the database within the RDFE's memory cache, and thus, for the duration of this transaction the database state is essentially “frozen” in that changes provided by other concurrent transactions (e.g., a SQL INSERT by another database node) are invisible. The RDFE node can parse the update request using, for example, the RDF parser 232. During parsing, the RDFE determines what update operation to perform, and what RDF object to perform the operation against. The update operation can comprise at least one of a write operation that inserts a new triple into a relational database table (e.g., INSERT, or a low-level write operation against one or more atoms) and a delete operation (e.g., DELETE, or a low-level removal of atoms) that removes existing triple from a particular relational table. The RDFE can support other RDF operations (e.g., CLEAR, LOAD) and this disclosure should not be construed as limiting in this regard. The RDFE node identifies the object to perform the write operation against by parsing the RDF syntax and identifying a resource to manipulate based on the resource's URI.

One such example SPARQL query 650 including an INSERT request is shown in FIG. 6b. As shown, the SPARQL query 650 includes an operation 652 and a namespace 654. Note, the namespace 654 is merely a means by which resources may be referenced in an abbreviated manner. For example, “dc:title” is an abbreviated form of “http://purl.org/dc/elements/1.1/title.” The scope of the operation 652 includes a subject URI 656, a predicate URI 662 and an object URI 664. Also included is an additional predicate URI 658 and an additional object URI 660. So, the RDF parser 232 can parse the SPARL query 650 and identify two triples to insert into a triple-store table. Within the specific example shown, the RDFE inserts the triples in the form of “Book1 has-title ‘A new book’” and “Book1 has-author ‘Jane Doe’”. As discussed below with regard to act 616, the RDFE node creates or updates a directed graph by inserting the new triples into the triple-store table using a SQL operation or a low-level write. Recall that triple stores can comprise one or more tables persisting triples (or parts of triples), depending on a table layout chosen. To this end, the RDFE can insert each triple into the same table, or a different table, as the case may be. FIG. 6c depicts on such example directed graph 666 based on the triples inserted by example SPARQL query 650.

Another such example SPARQL query 670 including a DELETE request is shown in FIG. 6d. As shown within the scope of the operation 655, a DELETE is directed at a resource identified by subject URI 672, predicate URI 674 and object URI 676. FIG. 6e illustrates the result of performing the SPARQL query 670 against the example directed graph 678. As shown, only the triple “Book1 has-author ‘Jane Doe’” remains within the triple-store table after deletion of the triple identified in the example SPARQL query of FIG. 6d.

Returning to FIG. 6a, and continuing to act 607, the RDFE node translates each URI identified in the update request received in act 604 to an internal identifier. As discussed above with regard to FIG. 4, a mapping table (e.g., a nodes table) can store associations between URIs and an internal identifier. Thus the RDFE can utilize the mapping table to perform the translation.

In act 608, the RDFE node determines one or more atoms affected by the RDF update request received in act 604. Recall that the distributed database system 100 can represent database objects with atoms. To this end, the RDFE node can locate those objects corresponding to triple-store tables affected by the update.

In act 609, the RDFE node can utilize modules of the platform layer 254 to create one or more triple-store tables if they do not otherwise exist. For example, the RDFE can create a database table and indexes (e.g., by creating atoms and inserting them into a catalog) based on a predefined table layout. Some such example table layouts are discussed above with regard to FIGS. 5a-e.

In act 610, the RDFE node determines if atoms affected by the RDFE query are within the RDFE's atom cache 210. For example, the distributed database system 100 may have an existing triple-store table, and thus, the RDFE retrieves atoms related to that table to perform an insert. Note the RDFE does not necessarily need to acquire every atom associated with a particular table to perform an insert. Instead, the RDFE can acquire just one atom (e.g., the “root” table atom) for the purpose of linking additional records against that table. In any event, the RDFE node can first check if the atom cache 210 includes the affected atoms, and if so, the method 600 continues to act 616. Otherwise, the method 600 continues to act 612.

In act 612, the RDFE node requests those atoms not available in the atom cache 210 from a most-responsive or otherwise low-latency peer database node. In act 614, the RDFE node receives the requested atoms and inserts them into its atom cache 210.

In act 616, the RDFE node updates the affected atoms identified in act 608 in accordance with the RDF update request received in act 604. As discussed above, this can include inserting new triples into one or more triple tables, or deleting triples from a particular triple-store table. In regard to inserting, the RDFE can create new atoms to represent triples and store those records within its atom cache 210. In regard to deleting triples, the RDFE does not necessarily need request and receive atoms through acts 612 and 614, and instead can issue a message that instructs those database nodes having that same atom to delete it or mark it for deletion such that a garbage collection process removes it at a later point. This is can also be referred to as a destructive replication message and will be discussed further below.

In act 618, the RDFE broadcasts a replication message to each peer database node to cause those nodes to update their peer instance of affected atoms accordingly. In some cases, the RDFE sends a copy of atoms created in act 616 to peer database nodes. In other cases, the RDFE sends a message that, when received by peer database nodes, causes those nodes to manipulate atoms within their respective atom cache. In any such cases, each peer database node receives a replication message and updates atoms within their atom caches such that an identical version of the database is present across the distributed database system 100, but invisible to queries by clients (including other RDFEs within the distributed database system 100). This update procedure may be accurately described as a symmetrical replication procedure. As discussed above, the RDFE can send a destructive replication message to delete records. This destructive replication message can include an atom identifier and an instruction to delete or otherwise mark that atom for deletion.

In act 620, the RDFE receives responses from each peer database node indicating that the “invisible” version is ready for finalization. In act 622, the RDFE ends the RDF transaction and broadcasts a commit message to all peer database nodes. As a result, each database node (including the RDFE) finalizes the version of the database created as a result of acts 616 and 618. Thus, the clients of the distributed database system 100 “see” an identical version of the database including those changes made in act 616 (e.g., assuming the transaction did not fail when committed). Method 600 ends in act 624.

Referring now to FIG. 6f, one example data flow of the method 600 is illustrated, in accordance with an embodiment of the present disclosure. As shown, a transaction begins at a first point in time at the RDFE node 110. For instance, a remote client may send the example SPARQL query 650 of FIG. 6b to the RDFE node 110. The RDFE can perform an RDF transaction in accordance with the example SPARQL query 650 and insert the triples referenced within the query within a triple-store table. As shown, this includes the RDFE node 110 performing in-memory updates to atoms in volatile memory (e.g., utilizing an atom cache).

In more detail, in-memory updates to a particular atom at the RDFE 110 are replicated to other database nodes having a peer instance of that atom. For example, and as shown, the RDFE node sends replication messages to nodes within the transaction tier 107 and the persistence tier 109, with those messages identifying one or more atoms and changes to those atoms. Note that only a some of the transaction tier nodes (e.g., TE nodes and RDFE nodes) may include an atom affected by the RDF transaction in their atom cache, so those nodes receive a message if they have one such atom. However, as discussed above, each SM and SSM node receives a copy of every atom change to make those changes “durable.”

In an embodiment, the replication messages sent to the database nodes can be the same or substantially similar, enabling each database node to process the replication message in a symmetrical manner. Thus, this update process may accurately be described as a symmetrical replication procedure. As discussed above with regard to FIG. 1, to enable transactional consistency (coherence) during performance of concurrent transactions, and to reduce lock-related latencies (e.g., by implementing MVCC), updates to atoms are manifested as multiple versions. One such example atom including multiple versions is shown in the example embodiment of FIG. 3. Thus, the each database node updates its own local peer instance (e.g., within its atom cache) of a given atom based on the replication messages received from the RDFE node 110. It should be appreciated that the RDFE node 110 can send replication messages at any time during transaction processing and not necessarily in the particular order shown in the example embodiment of FIG. 6f.

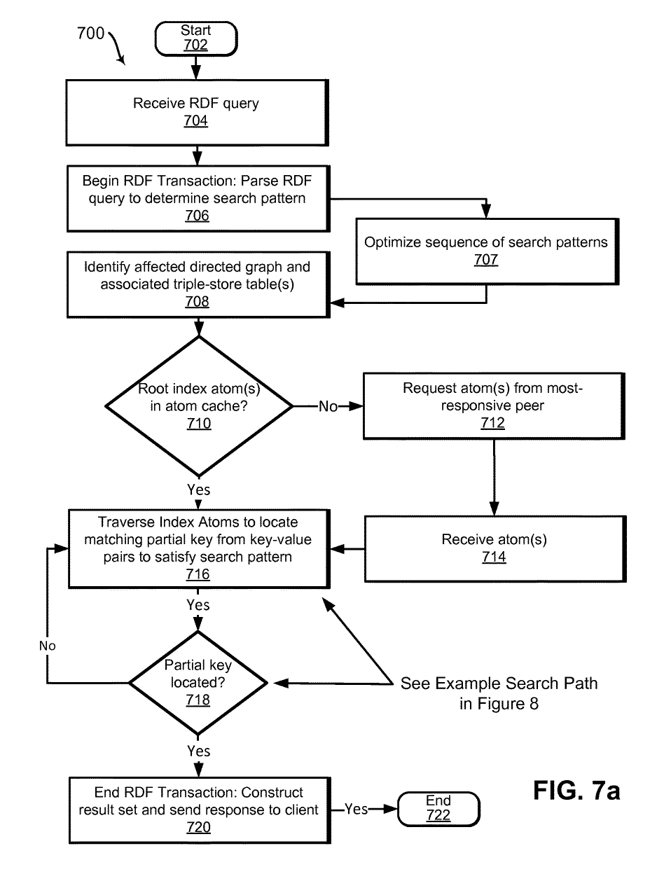

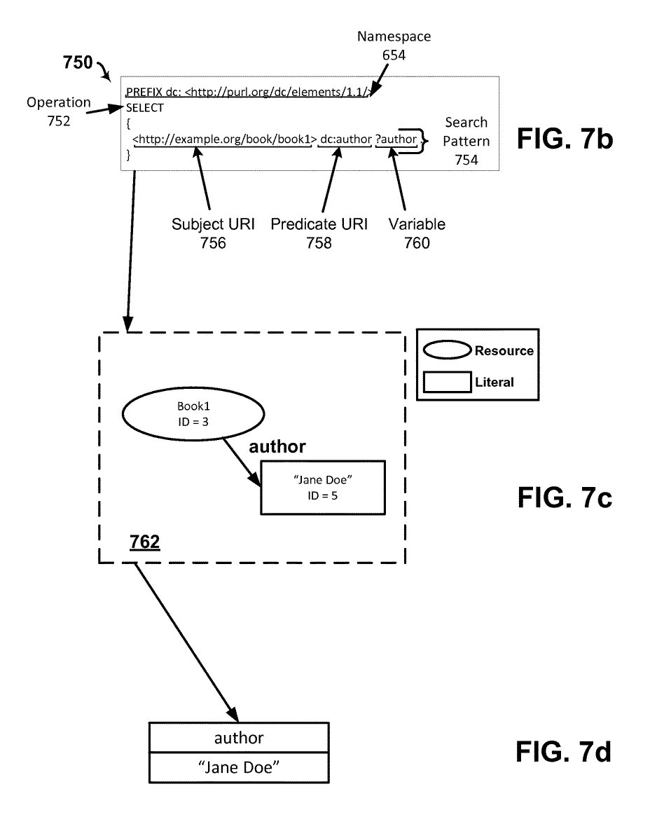

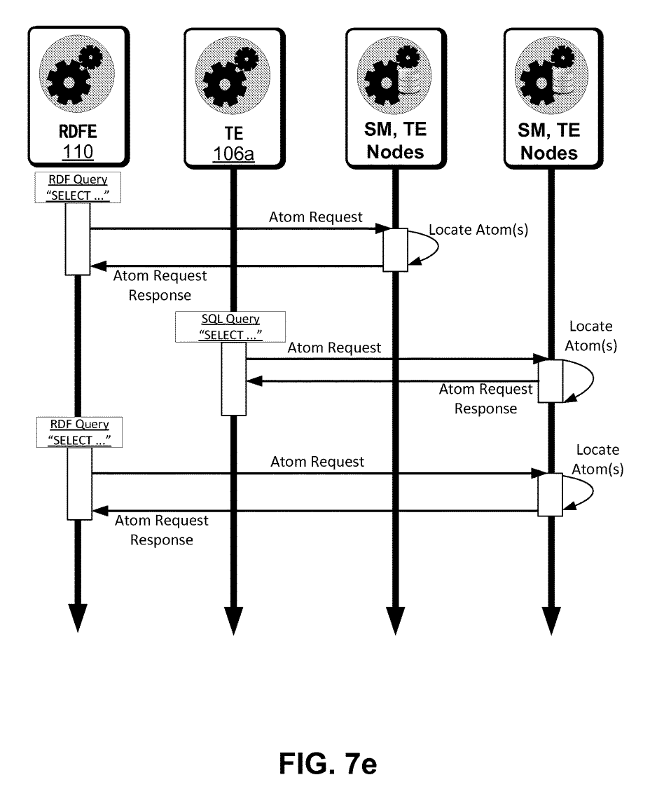

Referring now to FIG. 7a, a flowchart is shown illustrating an example method 700 for performing an RDF query (e.g., a SELECT). Method 700 may be implemented, for example, by the distributed database system 100 of FIG. 1, and more particularly by an RDFE node. Method 700 begins in act 702.

In act 704, the RDFE node receives an RDF query. In some cases, the RDFE node receives the query from an application that instantiated the RDFE node. For instance, the user application may execute a function of the API module 230 or otherwise instruct the RDFE node to perform a query operation. In other cases, the RDFE node receives the RDF query from a remote client via a SPARQL endpoint, such as the SPARQL endpoint 234.

In act 706, the RDFE node begins an RDF transaction and parses the RDF query received in act 704 to identify a search pattern. The search pattern can define one or more elements of a triple statement to search for. For example, a search pattern may include a query pattern that essentially states “find a book having authorX” or “find all books.” Note an RDF query can include multiple search patterns. Recall that transactions “see” a consistent version of the database within the RDFE node's memory cache, and thus, for the duration of this transaction the database state is essentially “frozen” in that changes provided by other concurrent transactions (e.g., a SQL INSERT by another database node) are invisible.

One such example SPARQL query 750 is depicted in FIG. 7b. As shown, the SPARQL query 750 includes a SELECT operation 752 and a search pattern 754. The example search pattern 754 includes a subject URI 756, a predicate URI 758, and a variable 760. This search pattern can be better understood by a plain-English equivalent, which is: “What author(s) wrote this book?.” Within this search pattern the variable 760 (?author) is essentially a placeholder value and allows the RDF parser 232 to provide a result set with that user-defined label. For example, as shown in FIG. 7d, a result set for the example SPARQL query 750 executed against directed graph 762 of FIG. 7c includes the value “Jane Doe” labeled “author.”

Returning to FIG. 7a, and continuing act 706, the RDFE node determines the search pattern by tokenizing or otherwise decomposing triples within the RDF query received in act 704.

In act 707, the RDFE node organizes the search patterns determined in act 706 into a sequence that optimizes query performance (e.g., to reduces I/O cost and query time). In an embodiment, the RDF optimizer 238 can enable such optimization by accessing statistics associated with the SQL tables and indexes used to implement the predicate layout.

In act 708, the RDFE node identifies a directed graph and one or more associated triple-store tables persisting that directed graph affected by the RDF query received in act 704. Recall that one or more triple-store tables can essentially represent a single directed graph. Therefore, the RDFE identifies a directed graph by locating the particular triple-store tables persisting that graph. In more detail, the RDFE node determines affected tables by, for example, translating a predicate URI from a triple decomposed in act 706. As discussed above with regard to FIG. 5b, one table layout option includes a predicate-layout option wherein each predicate is stored in a separate table. Thus the RDFE node can identify an affected table by looking up a given predicate URI in a “predicates” table that associates URIs to an internal identifier, and also to a table name within the distributed database. In other embodiments, the distributed database system 100 may include a single triple-store table (e.g., FIGS. 5a and 5c), and thus, no translation is necessary to identify the table.

In act 710, the RDFE node determines if the atom representing the root index for the one or more triple-store tables identified in act 708 exist within its atom cache 210. If any of the root index atoms for the triple-store tables identified in act 708 do not exist in the atom cache 210, the method 700 continues to act 716. Otherwise, the method 700 continues to act 712.

In act 712, the RDFE node requests the root index atoms for tables not presently within the RDFE node's atom cache. In an embodiment, the RDFE node requests these atoms from a most-responsive or otherwise low-latency peer database node. In act 714, the RDFE node receives the requested root index atoms and copies them into its atom cache 210.

In act 716, the RDFE node traverses the index atoms of the tables identified in act 708 to locate a matching partial key from the key-value pairs to satisfy the search pattern. Recall that index atoms are linked and can form a logical index structure. In one embodiment, the index atoms comprise a B-tree structure. One such example B-tree structure 800 is shown in FIG. 8. However, other tree structures will be apparent in light of the present disclosure such as doubly-linked lists, B+ tree index structures and Hash-based indexes, just to name a few. Continuing with the earlier example SPARQL query 750, wherein the query seeks to locate one or more authors of book1, the B-tree 800 shows one search path 801 the RDFE node can use to locate a result. More particularly, the RDFE node can translate the subject URI 756 to an internal identifier by using, for example, a mapping table that associates URIs with a corresponding internal identifier. In this specific example, book1 corresponds to identifier 3. Within the context of the tree structure, this identifier is also referred to as a partial key. So, the RDFE node starts at the root node “37” and identifies a next node by a simple comparison that continues down a search path to right if the node to locate has an identifier greater than the present node, and conversely, down a search path to the left if the node to locate has an identifier less than the present node. This process continues for each node until a leaf node is located, or not located, as the case may be. For example, an RDF query may not be serviceable because no leaf node has an identifier equal to the node being searched for. Note that the RDFE node may need to retrieve one or more additional index atoms to traverse the tree structure. To this end, the RDFE node can request and receive those additional atoms in a manner similar to acts 712 and 714. Further note that while examples provided herein traverse a single tree structure, the RDFE node can perform tree traversals against multiple triple-store tables to satisfy and RDF query, and this disclosure should not be construed a limited in this regard.

In any event, and in act 718, the RDFE node checks each node to identify if that node includes an identifier equal to the node being located. If the current node's identifier (partial key) is not equal to the node being located, the method 700 returns to act 716 to continue down the search path (e.g., search path 801) as discussed above. Otherwise, the method 700 continues to act 720.

In act 720, the RDFE node ends the RDF transaction and constructs a result set using the value stored in the key-value of a node located during acts 716 and 718. In an embodiment, the value stored in the key-value pair corresponds to an internal identifier. For example, as shown in FIG. 8, book1 corresponds to node ID=3, with the value for that node being 5. In an embodiment, the RDFE node converts the value into an RDF format by, for example, looking up the value in a mapping that associates internal identifiers with a corresponding resource URI. Note that the RDFE node can also convert the value into a literal using a different mapping that associates internal identifiers with a literal value. In an embodiment, the RDFE node determines whether to do URI resource mapping versus a literal mapping based on the internal identifier based on, for example, globally-unique identifiers that enable the RDFE node to decode whether the value is a resource or a literal. Also in act 720, the RDF sends the constructed result set to the client that requested in the RDF query in act 704. The method 700 ends in act 722.

The example RDF query statements provided herein are merely for illustration and should not be intended to be limiting. For example, the RDFE node can implement additional RDF-syntax and capabilities, such as any of the syntax and capabilities provided for within the RDF 1.1 Specification as published by the W3C.

Referring now to FIG. 7e, an example data flow illustrating an RDFE node 110 implementing the method 700 of FIG. 7a is shown, in accordance with an embodiment of the present disclosure. As shown, the RDFE node 110 enables a client application, or a remote client (e.g., via SPARQL endpoint 234), to “view” a single, logical database within the distributed database system and perform RDF queries thereon. In addition, the distributed database system can include a TE node, such as TE 106a, configured to enable a client (e.g., SQL client 102) to also “view” a single, logical database within the distributed database system 100 and perform SQL queries thereon. So, as shown, the RDFE node 110 and TE 106a are executing a plurality of queries against the distributed database system 100. Note, database nodes can execute queries concurrently and the separation in time shown between execution of RDF queries and SQL queries is merely for clarity and practicality.

Within the example context of the RDF query (“SELECT . . . ”) executed by the RDFE node 110, one or more atoms are unavailable in the atom cache of the RDFE node 110. In an embodiment, such atom availability determinations can be performed similar to act 710 of the method 700. As a result, the RDFE node 110 sends an atom request to a peer SM or TE node. In response, the peer node retrieves the requested atoms from its atom cache or its durable storage and then transmits back the requested atoms to the RDFE node 110. However, it should be appreciated that virtually any database node in the transaction tier 107 and/or the persistence tier 109 could be utilized by the RDFE node 110, because the RDFE node 110 can request atoms from any peer node having the target atom in a respective atom cache or durable storage, as the case may be. To this end, and in accordance with an embodiment, the RDFE node 110 can receive a first number of atoms from a first database node and a second number of atoms from any number of additional database nodes. In such cases, retrieved atoms, and those atoms already present in the atom cache of the RDFE node 110, can be utilized to service the query and return a result set in accordance with acts 706-720 of method 700 as discussed above.

Within the example context of the SQL query (“SELECT . . . ”) executed by the TE 106a, one or more atoms are unavailable in the atom cache of the TE 106a. As a result, the TE 106a sends an atom request to a peer SM or TE node. In response, the peer node locates the requested atoms from its atom cache or its durable storage and then transmits back the requested atoms to the TE 106a. However, it should be appreciated that virtually any database node in the transaction tier 107 and/or the persistence tier 109 could be utilized by the TE 106a because a database node can request atoms from any peer node having the target atom in a respective atom cache or durable storage, as the case may be. To this end, and in accordance with an embodiment, the TE 106a can receive a first of atoms from a first database node and a second number of atoms any number of additional database nodes. In such cases, retrieved atoms, and those atoms already present in the atom cache of the TE 106a, can be utilized to service the query and return a result set.

Computer System

FIG. 9 illustrates a computing system 1100 configured to execute one or more nodes of the distributed database system 100, in accordance with techniques and aspects provided in the present disclosure. As can be seen, the computing system 1100 includes a processor 1102, a data storage device 1104, a memory 1105, a network interface circuit 1108, an input/output interface 1110 and an interconnection element 1112. To execute at least some aspects provided herein, the processor 1102 receives and performs a series of instructions that result in the execution of routines and manipulation of data. In some cases, the processor is at least two processors. In some such cases, the processor may be multiple processors or a processor with a varying number of processing cores. The memory 1106 may be RAM and configured to store sequences of instructions and other data used during the operation of the computing system 1100. To this end, the memory 1106 may be a combination of volatile and non-volatile memory such as dynamic random access memory (DRAM), static RAM (SRAM), or flash memory, etc. The network interface circuit 1108 may be any interface device capable of network-based communication. Some examples of such a network interface include an Ethernet, Bluetooth, Fibre Channel, Wi-Fi and RS-232 (Serial) interface. The data storage device 1104 includes any computer readable and writable non-transitory storage medium. The storage medium may have a sequence of instructions stored thereon that define a computer program that may be executed by the processor 1102. In addition, the storage medium may generally store data in contiguous and non-contiguous data structures within a file system of the storage device 1104. The storage medium may be an optical disk, flash memory, a solid state drive (SSD), etc. During operation, the computing system 1100 may cause data in the storage device 1104 to be moved to a memory device, such as the memory 1106, allowing for faster access. The input/output interface 1110 may comprise any number of components capable of data input and/or output. Such components may include, for example, a display device, a touchscreen device, a mouse, a keyboard, a microphone, and speakers. The interconnection element 1112 may comprise any communication channel or bus established between components of the computing system 1100 and operating in conformance with standard bus technologies such as USB, IDE, SCSI, PCI, etc.

Although the computing system 1100 is shown in one particular configuration, aspects and embodiments may be executed by computing systems with other configurations. Thus, numerous other computer configurations are within the scope of this disclosure. For example, the computing system 1100 may be a so-called “blade” server or other rack-mount server. In other examples, the computing system 1100 may implement a Windows®, or Mac OS® operating system. Many other operating systems may be used, and examples are not limited to any particular operating system.

### Further Example Embodiments

Example 1 is a system comprising a network interface circuit configured to communicatively couple to a communication network, the communication network comprising a plurality of database nodes forming a distributed database, a memory for storing a plurality of database objects, and a resource description framework (RDF) engine configured with an RDF mode, the RDF mode configured to parse a first RDF query, the first RDF query including at least one search pattern, determine a directed graph to perform the first RDF query against, the directed graph being persisted in a relational database table, identify a plurality of table index objects associated with the relational database table, each table index object including a key-value pair, where the plurality of table index objects forms a logical index structure, traverse the logical index structure to identify a value from a key-value pair that satisfies the at least one search pattern, and construct a result set including the identified value, where traversing the logical index structure includes directly accessing table index objects in the memory without an intervening structured query language (SQL) operation.

Example 2 includes the subject matter of Example 1, where the first RDF query is received in response to a user application executing an application programming interface (API) function, and where the RDF mode is further configured to provide the constructed result set to the user application.

Example 3 includes the subject matter of any of Examples 1-2, where the first RDF query is received from a hypertext transfer protocol (HTTP) endpoint configured to service Simple Protocol and RDF query Language (SPARQL) requests from a remote client, and where the RDF mode is further configured to provide the constructed result set to the remote client.

Example 4 includes the subject matter of any of Examples 1-3, where the RDF mode is further configured to receive a replication message from a database node of the distributed database system, and where the replication message is configured to cause synchronization of database transactions such that a same database or portions thereof are stored in a memory within each of the plurality of database nodes.

Example 5 includes the subject matter of Example 4, where the replication message causes manipulation of a database object within the memory such that a new database object version is persisted in the memory, the new database object version representing a new triple inserted into the relational database table, and where the new triple is invisible to transactions until the RDF engine receives a commit message indicating a corresponding transaction was finalized.

Example 6 includes the subject matter of any of Examples 1-5, where the logical index structure comprises at least one of a Balanced-tree structure, a Hash-based index and a doubly-linked list.

Example 7 includes the subject matter of any of Examples 1-6, where the RDF mode implements Atomicity, Consistency, Isolation, and Durability (ACID) properties.

Example 8 is a computer-implemented method for executing RDF transactions against triple-store tables in a relational database, the method comprising parsing, by a processor, a first RDF query, the first RDF query including at least one search pattern, determining, by the processor, a directed graph to perform the first RDF query against, the directed graph being persisted in a relational database table, identifying, by the processor, a plurality of table index objects associated with the relational database table, each table index object including a key-value pair, where the plurality of table index objects forms a logical index structure, and traversing, by the processor, the logical index structure to identify a value from a key-value pair that satisfies the at least one search pattern and constructing a result set with the identified value, where traversing the logical index structure includes directly accessing table index objects in a memory without an intervening structured query language (SQL) operation.

Example 9 includes the subject matter of Example 8, where the first RDF query is received in response to a user application executing an application programming interface (API) function, and the method further comprising providing the constructed result set to the user application.

Example 10 includes the subject matter of any of Examples 8-9, where identifying a plurality of table index objects further includes retrieving at least one table index object from a durable distributed cache, the durable distributed cache being implemented by a plurality of database nodes forming a distributed database.

Example 11 includes the subject matter of Example 10, the method further comprising receiving a replication message from a database node of a distributed database system, where the replication message is configured to cause synchronization of database transactions such that a same database or portions thereof are stored in a memory within each of the plurality of database nodes, and where the memory of each of the plurality of distributed database nodes collectively forms a portion of the durable distributed cache.

Example 12 includes the subject matter of Example 10, where the replication message causes manipulation of a database object within the memory such that a new database object version is persisted in the memory, the new database object version representing a new triple inserted into the relational database table, and where the new triple is invisible to database transactions until a commit message is received indicating a corresponding transaction was finalized.

Example 13 includes the subject matter of any of Examples 8-12, where the logical index structure comprises at least one of a Balanced-tree structure, a Hash-based index, and a doubly-linked list.

Example 14 includes the subject matter of any of Examples 8-13, where the directed graph comprises a plurality of triple statements, each triple statement including a subject, a predicate and an object, and where each triple is stored in a relational database table based on its respective predicate.

Example 15 is a non-transitory computer-readable medium having a plurality of instructions encoded thereon that when executed by at least one processor cause a process to be carried out, the process configured to parse a first RDF query, the first RDF query including at least one search pattern, determine a directed graph to perform the first RDF query against, the directed graph being persisted in a relational database table, identify a plurality of table index objects associated with the relational database table, each table index object including a key-value pair, where the plurality of table index objects forms a logical index structure, and traverse the logical index structure to identify a value from a key-value pair that satisfies the at least one search pattern and construct a result set with the identified value, where traversing the logical index structure includes directly accessing the index objects in a memory without an intervening structured query language (SQL) operation.

Example 16 includes the subject matter of Example 15, where the first RDF query is received in response to a user application executing an application programming interface (API) function, and where the process is further configured to provide the constructed result set to the user application.

Example 17 includes the subject matter of any of Examples 15-16, where the first RDF query is received from a hypertext transfer protocol (HTTP) endpoint configured to service Simple Protocol and RDF query Language (SPARQL) requests from a remote client, and where the process is configured to provide the constructed result set to the remote client.

Example 18 includes the subject matter of any of Examples 15-17, where the plurality of table index objects are identified based on retrieving at least one table index object from a durable distributed cache, the durable distributed cache being implemented by a plurality of database nodes forming a distributed database.

Example 19 includes the subject matter of Example 18, where the process is further configured to receive a replication message from a database node of a distributed database system, and where the replication message is configured to cause synchronization of database transactions such that a same database or portions thereof are stored in a memory within each of the plurality of database nodes.

Example 20 includes the subject matter of Example 19, where the replication message manipulates a database object within the memory such that a new database object version is persisted in the memory, and where the new database object version is invisible to transactions until receiving a commit message indicating a corresponding transaction was finalized.

The foregoing description has been presented for the purposes of illustration and description. It is not intended to be exhaustive or to limit the disclosure to the precise form disclosed. It is intended that the scope of the disclosure be limited not by this detailed description, but rather by the claims appended hereto.

What is claimed is:

1. A system comprising:
a network interface circuit configured to communicatively couple to a communication network, the communication network comprising a plurality of database nodes forming a distributed database;
a memory for storing a plurality of database objects; and
a resource description framework (RDF) engine configured with an RDF mode, the RDF mode configured to:
parse a first RDF query, the first RDF query including at least one search pattern;
determine a directed graph to perform the first RDF query against, the directed graph being persisted in a relational database table;
identify a plurality of table index objects associated with the relational database table, each table index object including a key-value pair, wherein the plurality of table index objects forms a logical index structure; and
traverse the logical index structure to identify a value from a key-value pair that satisfies the at least one search pattern, and construct a result set including the identified value,
wherein traversing the logical index structure includes directly accessing table index objects in the memory without an intervening structured query language (SQL) operation.

2. The system of claim 1, wherein the first RDF query is received in response to a user application executing an application programming interface (API) function, and wherein the RDF mode is further configured to provide the constructed result set to the user application.

3. The system of claim 1, wherein the first RDF query is received from a hypertext transfer protocol (HTTP) endpoint configured to service Simple Protocol and RDF query Language (SPARQL) requests from a remote client, and wherein the RDF mode is further configured to provide the constructed result set to the remote client.

4. The system of claim 1, wherein the RDF mode is further configured to receive a replication message from a database node of the distributed database system, and wherein the replication message is configured to cause synchronization of database transactions such that a same database or portions thereof are stored in a memory within each of the plurality of database nodes.

5. The system of claim 4, wherein the replication message causes manipulation of a database object within the memory such that a new database object version is persisted in the memory, the new database object version representing a new triple inserted into the relational database table, and wherein the new triple is invisible to transactions until the RDF engine receives a commit message indicating a corresponding transaction was finalized.

6. The system of claim 1, wherein the logical index structure comprises at least one of a Balanced-tree structure, a Hash-based index and a doubly-linked list.

7. The system of claim 1, wherein the RDF mode implements Atomicity, Consistency, Isolation, and Durability (ACID) properties.

8. A computer-implemented method for executing RDF transactions against triple-store tables in a relational database, the method comprising:
parsing, by a processor, a first RDF query, the first RDF query including at least one search pattern;
determining, by the processor, a directed graph to perform the first RDF query against, the directed graph being persisted in a relational database table;
identifying, by the processor, a plurality of table index objects associated with the relational database table, each table index object including a key-value pair, wherein the plurality of table index objects forms a logical index structure; and
traversing, by the processor, the logical index structure to identify a value from a key-value pair that satisfies the at least one search pattern and constructing a result set with the identified value;
wherein traversing the logical index structure includes directly accessing table index objects in a memory without an intervening structured query language (SQL) operation.

9. The method of claim 8, wherein the first RDF query is received in response to a user application executing an application programming interface (API) function, and the method further comprising providing the constructed result set to the user application.

10. The method of claim 8, wherein identifying a plurality of table index objects further includes retrieving at least one table index object from a durable distributed cache, the durable distributed cache being implemented by a plurality of database nodes forming a distributed database.

11. The method of claim 10, the method further comprising receiving a replication message from a database node of a distributed database system, wherein the replication message is configured to cause synchronization of database transactions such that a same database or portions thereof are stored in a memory within each of the plurality of database nodes, and wherein the memory of each of the plurality of distributed database nodes collectively forms a portion of the durable distributed cache.

12. The method of claim 10, wherein the replication message causes manipulation of a database object within the memory such that a new database object version is persisted in the memory, the new database object version representing a new triple inserted into the relational database table, and wherein the new triple is invisible to database transactions until a commit message is received indicating a corresponding transaction was finalized.

13. The method of claim 8, wherein the logical index structure comprises a Balanced-tree structure, a Hash-based index and a doubly-linked list.

14. The method of claim 8, wherein the directed graph comprises a plurality of triple statements, each triple statement including a subject, a predicate and an object, and wherein each triple is stored in a relational database table based on its respective predicate.

15. A non-transitory computer-readable medium having a plurality of instructions encoded thereon that when executed by at least one processor cause a process to be carried out, the process configured to:
parse a first RDF query, the first RDF query including at least one search pattern;
determine a directed graph to perform the first RDF query against, the directed graph being persisted in a relational database table;
identify a plurality of table index objects associated with the relational database table, each table index object including a key-value pair, wherein the plurality of table index objects forms a logical index structure; and
traverse the logical index structure to identify a value from a key-value pair that satisfies the at least one search pattern and construct a result set with the identified value;
wherein traversing the logical index structure includes directly accessing the index objects in a memory without an intervening structured query language (SQL) operation.

16. The computer-readable medium of claim 15, wherein the first RDF query is received in response to a user application executing an application programming interface (API) function, and wherein the process is further configured to provide the constructed result set to the user application.

17. The computer-readable medium of claim 15, wherein the first RDF query is received from a hypertext transfer protocol (HTTP) endpoint configured to service Simple Protocol and RDF query Language (SPARQL) requests from a remote client, and wherein the process is configured to provide the constructed result set to the remote client.

18. The computer-readable medium of claim 15, wherein the plurality of table index objects are identified based on retrieving at least one table index object from a durable distributed cache, the durable distributed cache being implemented by a plurality of database nodes forming a distributed database.

19. The computer-readable medium of claim 18, wherein the process is further configured to receive a replication message from a database node of a distributed database system, and wherein the replication message is configured to cause synchronization of database transactions such that a same database or portions thereof are stored in a memory within each of the plurality of database nodes.

20. The computer-readable medium of claim 19, wherein the replication message manipulates a database object within the memory such that a new database object version is persisted in the memory, and wherein the new database object version is invisible to transactions until receiving a commit message indicating a corresponding transaction was finalized.
